(19) United States
(12) Patent Application Publication
(10) Pub. No.: US 2024/0046277 A1
(43) Pub. Date: Feb. 8, 2024

(54) A SALES SUPPORT SYSTEM AND A SALES SUPPORT METHOD

(71) Applicant: Hiroyuki UGAWA, (US)

(72) Inventor: Hiroyuki UGAWA, (US)

(21) Appl. No.: 17/761,913

(22) PCT Filed: Jan. 20, 2022
(86) PCT No.: PCT/JP2022/001973

§ 371 Date: Mar. 18, 2022

(51) Int. Cl. G06Q 30/015

(52) U.S. Cl. CPC G06Q 30/015

(57) ABSTRACT

The parties concerned including the sales staff or the customer himself/herself can accurately grasp the customer's problem and efficiently provide a service (product) suitable for solving the problem. According to the present invention, the problem organization database 321 is hierarchically connected to at least the problem, the measure to solve the problem, and the service to contribute to the measure. A plurality of problems set in the problem database 321 are displayed to be selectable on the display screen of the sales terminal that can be operated by the parties concerned including the sales staff or the customer himself/herself, and when the plurality of problems displayed on the display screen are selected, the plurality of measures connected to the lower layer of the plurality of problems are displayed, and when the plurality of measures displayed on the display screen are selected, the plurality of selected services connected to the lower layer of the measures are displayed.

### TECHNICAL FIELD

The present invention relates to a sales support system and a sales support method for supporting the sales activities of related parties including sales staff who go to customers such as companies and companies to conduct business negotiations, or for the customers themselves to use.

### BACKGROUND TECHNOLOGY

In general, the sales staff conducts business negotiations with customers and conducts sales activities to propose and sell the most suitable products according to the customer's request or the actual situation. Information obtained from sales activities by a specific sales staff is stored so that it can be shared with other sales staff, so that even if other sales staff conduct sales activities, it is tailored to the customer. It will be possible to hold business negotiations.

For example, in Patent Document 1 below, an explanatory material tag in which a product to be sold, an explanatory material among the explanatory materials used for explaining the product, and a plurality of contents constituting the explanatory material are associated with each other. A sales support server that creates an attached table and creates a customer preference table that associates a customer to be sold with the preference of the customer is described. When the search information is input from the sales terminal (sales terminal) which is an external terminal, the sales support server refers to the customer preference table, acquires the customer preference included in the search information, and tags the explanatory material. It is possible to acquire the acquired content that satisfies the customer's preference and propose the acquired content that satisfies the customer's preference and the customer's preference as a sales method that matches the customer's preference.

For example, Patent Document 2 below describes a business support system provided with a plurality of unit business databases that systematically link solutions to problems given to each unit business. In the unit business database, information that summarizes past know-how and examination results is summarized in a flowchart format. The unit business database is composed of a series of problems consisting of a plurality of layers, and converges on a solution method at any stage. Various questions are displayed as problems in the unit business database, and the solution method is derived by the user selecting the problem.

For example, Patent Document 3 below describes a solution proposal support system that presents an optimum solution to a problem selected by a user in order to propose an optimum solution to a customer. Here, a problem (problem tree) having a tree structure is used, so that the user can select a problem and create a problem tree, and can create a solution tree corresponding to the problem tree. Further, the user can give weighting points to each problem. When weighting points are given to a problem, the weighting points are distributed to the solutions corresponding to the problems, and the solutions are ranked and displayed by the total points of the solutions having a tree structure.

### PRIOR ART

### Patent Literature

[Patent Document 1] U.S. Pat. No. 6,533,416
[Patent Document 2] Republished Patent WO2015/122118 Gazette
[Patent Document 3] Japanese Patent Publication No. 2008-3931

### SUMMARY OF THE INVENTION

### Technical Problem

The technology described in Patent Document 1 proposes a sales method such as the optimum content to be used at the time of business negotiation and the optimum explanation order according to the customer's preference when explaining the product to the customer. It is valid in terms of points. However, the problem itself is often not clear on the customer side, and the technology described in Patent Document 1 is used when conducting sales activities in which a plurality of products are prepared and a product suitable for the customer is proposed. There is a problem that it is difficult to identify what kind of product is most suitable for the customer because the problem is unclear. As a result, there is a problem that it depends on the skills and knowledge of the sales staff when identifying the customer's problem and proposing the optimum product.

In the technology described in Patent Document 2, the sales staff can derive a specific solution method from a specific problem by following a flowchart that converges from the problem to the solution method. However, in the technique described in Patent Document 2, as a result of following the flowchart of the problem tree for a specific problem, only a single solution method can be reached, which is flexible and diverse for customers. There is a problem that it is not possible to propose a solution method.

In the technique described in Patent Document 3, by weighting each problem while referring to the problem tree in which the problems are classified hierarchically, it is possible to classify the problems that the customer has in detail. It is now possible to rank the solutions. However, in the technique described in Patent Document 3, since the user sets the weighting arbitrarily, the weighting by the user is only an arbitrary choice by the user, and the ranking of the solutions is personal. There is a problem. Further, in the technique described in Patent Document 3, a group of solutions is presented for each problem specified by the user by giving a weight, but comparison between solutions included in different problems is made. And no ranking is done. Therefore, there is a problem that the selection of the solution group related to each problem depends on the judgment of the user at that time.

The present invention has been made in view of the above problems, and a person concerned including a sales staff or a customer himself/herself can accurately grasp a customer's problem and efficiently provide a service (product) suitable for solving the problem. The purpose is to provide a sales support system and a sales support method for providing sales support so that the customer can be identified,

### Means to Solve the Problem

In order to achieve the above object, the sales support system according to the present invention is a sales support system that supports the sales activities of related parties including the sales staff who negotiate with the customer company, or the sales support system used by the customer himself/herself,
comprising: a sales terminal that can be operated by the person concerned including the sales staff or the customer; and a sales support device that can communicate with the sales terminal, wherein, the sales support device has
a problem organization database, systematically connected to at least the problems, the measures to solve the problems, and the services contributing to the problems, and
a sales support processing unit that: displays a plurality of problems set in the problem organization database on the display screen of the sales terminal so that the problems can be selected; displays the plurality of measures connected to the lower layers of the plurality of problems on the display screen of the sales terminal so that the measures can be selected, when the plurality of problems displayed on the display screen of the sales terminal are selected; and displays the plurality of services connected to the lower layers of the plurality of services on the display screen of the sales terminal, when the plurality of measures displayed on the display screen of the sales terminal are selected.

According to the above sales support system, related parties including sales staff or customers themselves can accurately grasp customer problems and efficiently identify services (products) suitable for solving the problems. In addition, the obtained data can be utilized in the subsequent PDCA (Plan (plan), Do (execution), Check (evaluation), Action (improvement)) cycle, and the data obtained in business negotiations, and the like can be utilized in grasping the problem not touched in that business negotiation in order to connect to the subsequent business negotiation. Specifically, when realizing multiple solutions to multiple problems that a customer has, even if all or part of the problems that the customer has cannot be solved in one business negotiation, the result data can be accumulated and used for the same customer, for example, at the time of replacement several years later. This cycle of data storage and utilization can be regarded as a PDCA cycle, and by utilizing the data obtained in the present invention for such a PDCA cycle, it will be possible to continue to identify a service (product) suitable for identifying a problem and solving the problem.

In the sales support system according to the present invention, the sales support processing unit may collectively display the plurality of selected problems, the plurality of selected measures, and the plurality of services connected to the lower layers of the plurality of the selected measures on the display screen of the sales terminal.

According to the above sales support system, related parties including sales staff or customers themselves can comprehensively grasp the whole picture of the items selected by themselves.

In the sales support system according to the present invention, the sales support device has a weighted value setting unit that assigns a weighted value to each of a plurality of connection routes having a service hierarchy as an end point from the problem hierarchy to the measure hierarchy in the problem organization database.

When the sales support processing unit displays a plurality of services on the display screen of the sales terminal, the display priority of the plurality of services to be displayed may be determined based on the weighted value set in a connection path having each of the plurality of services to be displayed as an end point.

According to the above sales support system, it becomes possible to set a weighted value for each connection route whose end point is the service hierarchy from the problem hierarchy to the measure hierarchy. The connection route is consistent with the flow of consideration when identifying measures and services from the problems faced by the company, and the parties concerned including sales staff or the customers themselves intuitively and accurately grasp the problems of the customer. Therefore, it becomes possible to efficiently identify services (commodities) suitable for solving problems.

In the sales support system according to the present invention, the weighted value setting unit may set the weighted value based on the company attribute.

According to the above sales support system, companies can be classified according to company attributes, weighted values can be set appropriately, and service display priority can be determined.

In the sales support system according to the present invention, the corporate attribute may include at least one of the business type, scale, listing classification, and region of the company.

According to the above sales support system, companies can be classified according to at least one of the company's industry, scale, listing classification, and region, weighted values can be set appropriately, and service display priority can be determined.

In the sales support system according to the present invention, the weighted value setting unit may set the weighted value based on the negotiation history for another company having the same company attribute.

According to the above sales support system, it becomes possible to appropriately set weight values based on the past negotiation history and determine the display priority of services for companies with the same company attributes.

In the sales support system according to the present invention, the weighted value setting unit may set the weighted value according to the progress of the negotiation.

According to the above sales support system, it becomes possible to appropriately set weighted values based on the progress of business negotiations and determine the display priority of services.

In the sales support system according to the present invention, the weighted value setting unit may set the weighted value based on the information about the company obtained in the negotiation or the survey.

According to the above sales support system, the weighted value is set appropriately by utilizing the information about the company obtained in the negotiation (business negotiation result data) and it is possible to determine the display priority of the information about the company collected in the site survey (collected data), and the service.

In the sales support system according to the present invention, the information about the company is text data, and the weighted value setting unit may set the weighted value based on the word extracted from the text data. Further, in the sales support system according to the present invention, the information about the company is audio data, and the weighted value setting unit may set the weighted value based on the word extracted from the audio data. Further, in the sales support system according to the present invention, the information about the company is image data, and the weighted value setting unit may set the weighted value based on the object detected from the image data.

According to the above sales support system, it will be possible to appropriately set weighting values and determine service display priorities by utilizing texts, voices, and images obtained from business negotiations and site surveys.

In the sales support system according to the present invention, the weighted value setting unit may extract features of information about the company by deep learning technology and set the weighted values based on the extracted features.

According to the above sales support system, even if the information obtained in business negotiations or site surveys is complicated, the display priority of the service may be determined by extracting the characteristics of the information and reflecting it in the weighted value.

In the sales support system according to the present invention, in the problem organization database, a layer including a problem derivation item for deriving the problem is connected as an upper layer of the problem, the sales support processing unit displays a plurality of problem derivation items for deriving the problem on the display screen of the sales terminal so that a plurality of the problem deviation items can be selected, when a plurality of problem deviation items displayed on the display terminal of the sales terminal are selected, a plurality of problems connected to a lower layer of the plurality of selected problem derivation items are displayed on the display screen of the sales terminal.

According to the above sales support system, it becomes possible to identify the customer's problem by selecting the problem derivation item for deriving the problem.

In the sales support system according to a present invention, a management vision, a strategic theme, a business flow, and an action theme may be hierarchically connected in the layer including the problem derivation item.

According to the above sales support system, it becomes possible to identify customer problems through a series of processes of management vision, strategic theme, business flow, and action theme.

Further, in order to achieve the above object, the sales support method according to the present invention is the sales support method in the sales support system that supports the sales activities of related parties including the sales staff who negotiate with the customer company, or the sales used by the customer himself/herself, wherein the sales support method has:
a step to prepare a problem organization database in which at least a problem, a measure to solve the problem, and a service that contributes to the measure are hierarchically connected;
a step to display a plurality of problems that are set in a problem organization database so that a plurality of problems can be selected on a display screen of a sales terminal that can be operated by the related parties including the sales staff or the customer himself/herself,
a step to display a plurality of measures that are connected to a lower layer of the plurality of the selected problems when a plurality of problems displayed on the display screen of the sales terminal are selected; and
a step to display a plurality of services that are connected to a lower layer of the plurality of the selected measures when a plurality of measures displayed on the display screen of the sales terminal are selected.

According to the above sales support method, related parties including sales staff or the customer himself/herself can accurately grasp the customer's problem and efficiently identify the service (product) suitable for solving the problem. In addition, the obtained data can be utilized in the subsequent PDCA cycle, and by using the data obtained in business negotiations, and the like, to understand problems that were not mentioned in the business negotiations at that time, it is possible to move on to the next business negotiation. It is possible to connect. Specifically, when realizing multiple solutions to multiple problems that a customer has, even if all or part of the problems that the customer has cannot be solved in one negotiation, the negotiation result data can be accumulated and used for the same customer, for example, at the time of replacement several years later. This cycle of data storage and utilization can be regarded as a PDCA cycle, and by utilizing the data obtained in the present invention for such a PDCA cycle, a service (commerce) suitable for identifying a problem and solving the problem. It will be possible to continue to identify the material) efficiently.

### Effect of the Invention

According to the sales support system and the sales support method according to the present invention, the parties concerned including the sales staff or the customer himself/herself can accurately grasp the customer's problem and efficiently provide a service (product) suitable for solving the problem.

### BRIEF EXPLANATION OF DRAWINGS

FIG. 1 is a diagram showing an example of a configuration of a sales support system according to an embodiment of the present invention.

FIG. 2 is a schematic block diagram showing an example of a hardware configuration of a sales terminal according to an embodiment of the present invention.

FIG. 3 is a schematic block diagram showing an example of a hardware configuration of a site survey terminal according to an embodiment of the present invention.

FIG. 4 is a schematic block diagram showing an example of a hardware configuration of a sales support device according to an embodiment of the present invention.

FIG. 5 is a functional block diagram showing an example of the function of the sales support system according to the embodiment of the present invention.

FIG. 6 is a diagram schematically showing the concept of a problem organization database in the embodiment of the present invention.

FIG. 7 is a diagram for explaining the concept of weighting for a problem organization database in the embodiment of the present invention.

FIG. 8 is a diagram showing a part of a problem organization database used for explaining a specific operation example in the embodiment of the present invention.

FIG. 9 is a diagram showing an example of a customer selection screen according to the embodiment of the present invention.

FIG. 10 is an example of a management goal selection screen in the embodiment of the present invention.

FIG. 11 is an example of a business flow selection screen in the embodiment of the present invention.

FIG. 12 is an example of an action theme selection screen in the embodiment of the present invention.

FIG. 13 is an example of a problem selection screen in the embodiment of the present invention.

FIG. 14 is an example of a measure selection screen in the embodiment of the present invention.

FIG. 15 is an example of a service selection screen according to the embodiment of the present invention.

FIG. 16 is an example of an optimum solution proposal screen in the embodiment of the present invention.

FIG. 17 is an example of a business negotiation result registration screen in the embodiment of the present invention.

FIG. 18 is a diagram showing an example of a weighted value setting process from corporate information in the embodiment of the present invention.

FIG. 19 is an example of case information referred to in the embodiment of the present invention.

FIG. 20 is an example of a scenario table referred to in the embodiment of the present invention.

FIG. 21 is an example of a case management table referred to in the embodiment of the present invention.

FIG. 22 is an example of a company classification table in the embodiment of the present invention.

FIG. 23A is an example of a weighting table for each company category of the company category ID “1” in the embodiment of the present invention.

FIG. 23B is an example of a weighting table for each company category of the company category ID “2” in the embodiment of the present invention.

FIG. 24 is a diagram showing an example of a weighted value setting process from text data in the embodiment of the present invention.

FIG. 25 is an example of a word list table referred to when extracting words in the embodiment of the present invention.

FIG. 26 is an example of word information obtained by extracting a word from text data in the embodiment of the present invention.

FIG. 27 is an example of an existing word dictionary/weighting table in the embodiment of the present invention.

FIG. 28 is a diagram showing an example of a weighting visualization process in the embodiment of the present invention.

FIG. 29 is a diagram showing an example of a weighted value setting process from audio data in the embodiment of the present invention.

FIG. 30 is a diagram showing an example of a weighting visualization process based on audio data in the embodiment of the present invention.

FIG. 31 is a diagram showing an example of a weighted value setting process from image data in the embodiment of the present invention.

FIG. 32 is an example of an object list table referred to when extracting a word in the embodiment of the present invention.

FIG. 33 is an example of object information obtained by extracting an object from image data in the embodiment of the present invention.

FIG. 34 is an example of an existing object dictionary/weighting table in the embodiment of the present invention.

FIG. 35 is a diagram showing an example of a weighting visualization process based on image data in the embodiment of the present invention.

### DETAILED DESCRIPTION OF EMBODIMENTS

Hereinafter, embodiments of the present invention will be described with reference to the drawings.

<System Configuration>

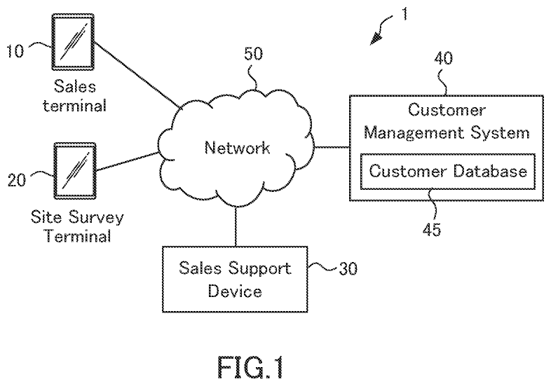

The configuration of the sales support system according to the embodiment of the present invention will be described with reference to FIG. 1. FIG. 1 is a diagram showing an example of the configuration of the sales support system according to the present embodiment. The sales support system according to the present invention is not limited to the configuration shown in FIG. 1.

As an example, the sales support system 1 shown in FIG. 1 includes a sales terminal 10, a site survey terminal 20, a sales support device 30, and a customer management system 40.

The sales terminal 10 is a terminal that can be operated by a person concerned including a sales staff (sales person) who negotiates with a customer or the customer himself/herself. The persons concerned include the person in charge of system design and the like. The sales terminal 10 is, for example, a portable notebook personal computer, a tablet terminal, or the like, and is configured to be usable when a sales employee goes to a company that is a customer. The sales terminal 10 is configured to connect to a network 50 such as the Internet and communicate with a business support device 30 having a web server function.

In the following, the case where the sales staff operates the sales staff 10 will be mainly described, but the sales terminal 10 may be a terminal owned by the customer, or the customer may be able to access the sales support device 30 from the sales terminal owned by the customer himself/herself (that is, in the absence of the sales staff) via a network 50. When the customer himself/herself uses the sales support device 30 to use the sales support function of the sales support device 30, the customer himself/herself operates the sales terminal 10 from the upper layer of the problem organization database 321 as described later. It is possible to trace toward the lower layer, select multiple problems and multiple measures as appropriate, and finally identify multiple services that are appropriate for the customer himself/herself.

The sales terminal 10 is configured to communicate with the sales support device 30 via the network 50 and to use the sales support function provided by the sales support device 30. Even if the sales terminal 10 is a thin client terminal having only the minimum necessary functions of displaying the information provided by the sales support device 30 and transmitting the data input by the sales staff at the time of business negotiation to the sales support device 30. The processing related to the sales support function may be executed on the cloud (sales support device 30 side).

The site survey terminal 20 is a terminal that can be operated by a site surveyor. The site survey terminal 20 is, for example, a portable terminal such as a notebook personal computer or a tablet terminal, and it is used when a site surveyor goes to a company site (company warehouse, factory, and the like) to conduct a site survey. Specifically, the site surveyor can use the site survey terminal 20 to make a note of the actual site situation, record a conversation with a site worker, and shoot the site situation. The field investigator may be the same person as the sales staff or a different person.

The site survey terminal 20 is configured to be able to transfer various data (collected data) recorded at the site to the sales support device 30. The collected data may be transferred from the site survey terminal 20 to the sales support device 30 via a network 50 such as the Internet, or may be via an in-house LAN or the like.

The sales support device 30 is a server device for realizing a sales support function for supporting the sales of sales staff. The sales support device 30 functions as a web server for the sales terminal 10 and is configured to be able to provide the sales support function to the sales terminal 10.

The customer management system 40 is a device that manages information (customer data) of a company that is a customer. The customer management system 40 has a customer database 45 that stores company information collected by various means. The sales support device 30 is configured to take in company information such as a company name, an industry, a scale, and a management goal from the customer management system 40, and to support the business of the company by using the company information.

Although FIG. 1 shows one sales terminal 10 and one site survey terminal 20, there may be a plurality of each of the sales terminal 10 and the site survey terminal 20. Further, the sales support device 30 may be configured by one device, or each function may be distributed to a plurality of devices.

<Structure of Sales Terminal>

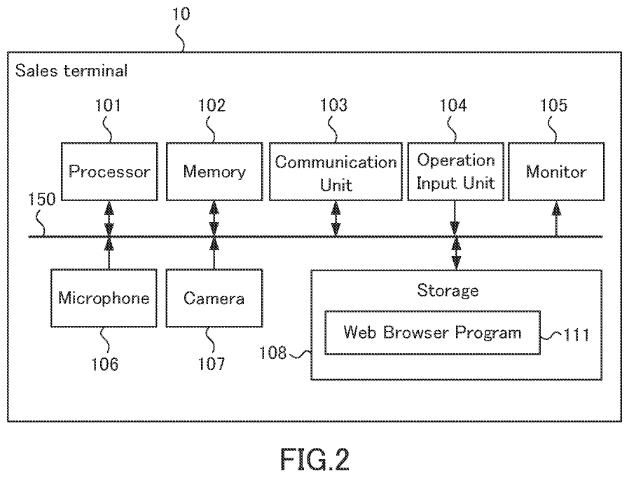

The configuration of the sales terminal 10 according to the embodiment of the present invention will be described with reference to FIG. 2. FIG. 2 is a schematic block diagram showing an example of the hardware configuration of the sales terminal 10 according to the embodiment of the present invention. The sales terminal 10 according to the present invention is not limited to the configuration shown in FIG. 2.

As described above, the sales terminal 10 can be realized by a portable terminal, and as an example, as shown in FIG. 2, a processor 101, a memory 102, a communication unit 103, an operation input unit 104, a monitor 105, and a microphone (microphone). It has 106, a camera 107, and a storage 108, and each component is connected via a bus 150.

The processor 101 is hardware that executes various instructions described in a program and realizes and controls various functions in the sales terminal 10. The processor 101 is, for example, a CPU (Central Processing Unit), a DSP (Digital Signal Processor) or a GPU (Graphics Processing Unit) that performs data processing specialized for a specific purpose, and the like.

The memory 102 is a volatile memory that temporarily stores a program executed by the sales terminal 10 and data to be processed. The memory 102 is a main storage device such as a RAM (Random Access Memory).

The communication unit 103 has a function for the sales terminal 10 to communicate with another device. In the present embodiment, the sales terminal 10 can communicate with the sales support device 30 through the network 50 by the communication unit 103.

The operation input unit 104 has a function of receiving information input from a user, and represents an input device such as a mouse and a keyboard, for example. Further, the monitor 105 has a function of outputting visual information to the user, and has a display screen. The operation input unit 104 and the monitor 105 may be a touch panel type display in which the respective functions are integrated.

The microphone 106 has a sound collecting function, and the camera 107 has a shooting function. The sales staff can record and shoot the state of the business negotiation using the microphone 106 and the camera 107. However, the microphone 106 and the camera 107 do not necessarily have to be provided in the sales terminal 10. Further, the sales terminal 10 may be appropriately provided with various other devices such as a speaker and the like.

The storage 108 is an auxiliary storage device realized by, for example, a magnetic disk such as an HDD (Hard Disk Drive), a semiconductor memory such as an SSD (Solid State Drive), an optical magnetic disk, an optical disk, or the like.

The storage 108 can store a program or data in which a desired processing procedure is described as a program instruction. For example, as shown in FIG. 2, the Web browser program 111 is stored in the storage 108.

The processor 101 appropriately reads each program from the storage 108, expands it on the memory 102, and executes a program instruction, so that the function corresponding to each program can be realized in the sales terminal 10. The sales terminal 10 displays a web page received from the sales support device 30 having a web server function by executing the Web browser program 111 in particular, and gives instructions and text data input by a salesperson using the operation input unit 104, and the like can be transmitted to the sales support device 30.

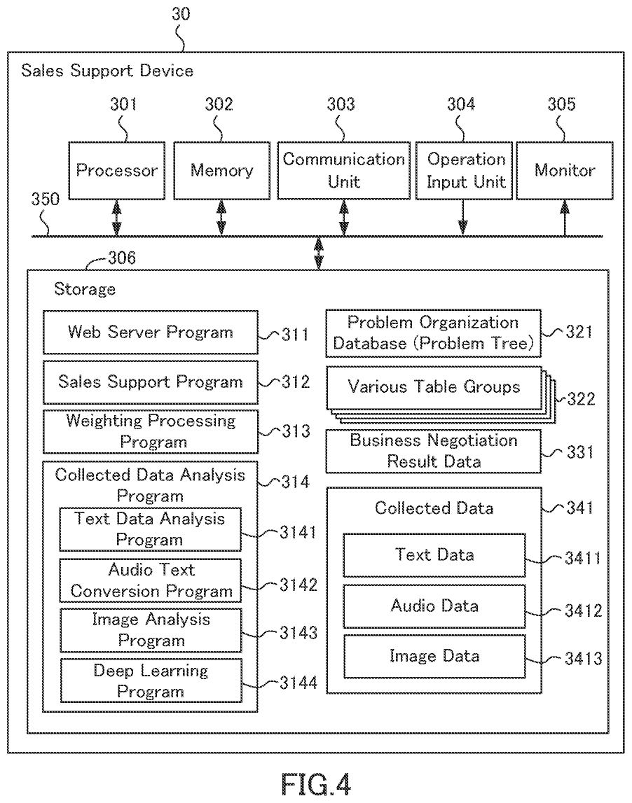

The storage 108 can store various programs and various data. As an example, the storage 108 may store various programs such as an operation system program necessary for the operation of the sales terminal 10, a recording processing program that processes the sound picked up by the microphone 106 into file format sound data, a shooting processing program that processes the image shot by the camera 107 into an image data of a file format, and the like. Further, in the present embodiment, the data input by the sales staff using the sales support function of the sales support device 30 is stored on the sales support device 30 side, and these data may be stored in the storage 108 of the sales terminal 10. In this specification, text data input by a salesperson at the time of negotiation, audio data recorded using a microphone 106, and image data taken using a camera 107 are collectively referred to as business negotiation result data 331 (see FIG. 4).

<Configuration of Site Survey Terminal>

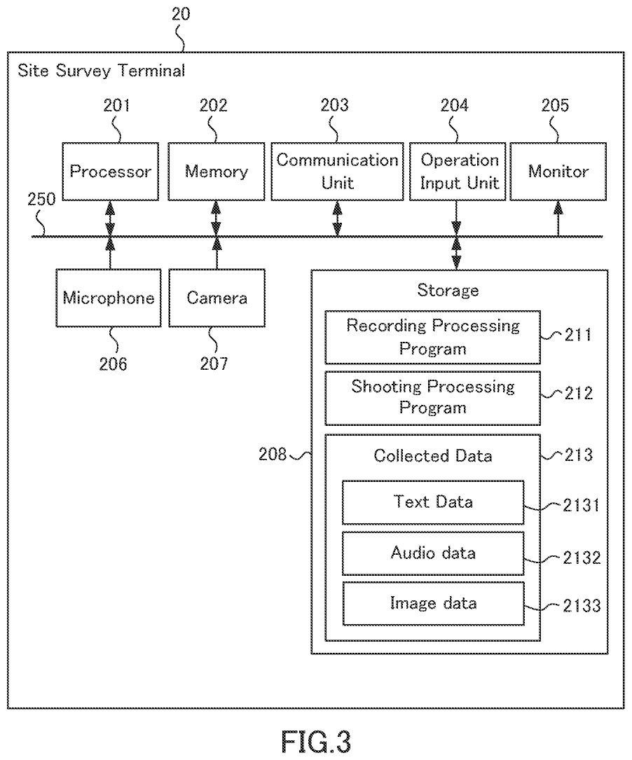

The configuration of the site survey terminal 20 according to the embodiment of the present invention will be described with reference to FIG. 3. FIG. 3 is a schematic block diagram showing an example of the hardware configuration of the site survey terminal 20 according to the embodiment of the present invention. The site survey terminal 20 according to the present invention is not limited to the configuration shown in FIG. 3.

The site survey terminal 20 can be realized by a portable terminal as described above, and has the same configuration as the sales terminal 10. As an example, the site survey terminal 20 has a processor 201, a memory 202, a communication unit 203, an operation input unit 204, a monitor 205, a microphone (microphone) 206, a camera 207, and a storage 208. Each component is connected via the bus 250. The processor 201, memory 202, communication unit 203, operation input unit 204, monitor 205, microphone 206, camera 207, and storage 208 of the site survey terminal 20 are the processor 101, memory 102, communication unit 103, operation input unit 104, monitor 105, microphone 106, camera 107, and storage 108, and detailed description thereof will be omitted here.

The sales terminal 10 is used when a salesperson goes to a company that is a customer to conduct business negotiations, whereas the site survey terminal 20 is used by a site surveyor at a company's site (company warehouse, factory, and the like), and it is used when conducting a site survey. This means that the site survey terminal 20 has a function necessary for conducting a site survey. Specifically, it has a recording function for recording a conversation with a site worker and a shooting function for shooting the situation at the site.

In the storage 208, for example, as shown in FIG. 3, a recording processing program 211 that processes the sound picked up by the microphone 206 into file format sound data, and an image taken by the camera 207 into file format image data or video data. The shooting processing program 212 to be processed is stored. Further, the storage 208 stores text data 2131 input by the site surveyor, audio data 2132 recorded using the microphone 206, and image data 2133 taken by the camera 207. In the present specification, the text data 2131, the audio data 2132, and the image data 2133 collected in the site survey by the site surveyor may be collectively referred to as the collected data 213.

In the above example, the case where the sales terminal 10 and the site survey terminal 20 are different terminals is illustrated, but the sales terminal 10 and the site survey terminal 20 may be regarded as the same terminal (that is, one terminal). The one terminal may have the functions of both the sales terminal 10 and the site survey terminal 20 described above.

<Configuration of Sales Support Equipment>

The configuration of the sales support device 30 according to the embodiment of the present invention will be described with reference to FIG. 4. FIG. 4 is a schematic block diagram showing an example of the hardware configuration of the sales support device 30 according to the embodiment of the present invention. The sales support device 30 according to the present invention is not limited to the configuration shown in FIG. 4.

The sales support device 30 is a server device for realizing the sales support function according to the present invention. The sales support device 30 has a processor 301, a memory 302, a communication unit 303, an operation input unit 304, a monitor 305, and a storage 306, and each component is connected via a bus 350.

The processor 301 is hardware that executes various instructions described by a program and realizes and controls various functions in the sales support device 30. The memory 302 is a volatile memory that temporarily stores a program executed by the sales support device 30 and data to be processed. The communication unit 303 has a function for the sales support device 30 to communicate with other devices. In the present embodiment, the sales support device 30 can communicate with the sales terminal 10, the site survey terminal 20, and the customer management system 40 through the network 50 by the communication unit 303.

The operation input unit 304 has a function of receiving information input from the user, and the monitor 305 has a function of outputting visual information to the user. The operation input unit 304 and the monitor 305 may be usable as long as they can be used by the user (operator) of the sales support device 30 when making settings and management in the sales support device 30, and need not be always connected to the sales support device 30.

The storage 306 is an auxiliary storage device that stores programs and data in which a desired processing procedure is described as a program instruction. For example, as shown in FIG. 4, the storage 306 stores a web server program 311, a sales support program 312, a weighting processing program 313, a collected data analysis program 314, a problem organization database (problem tree) 321, various table groups 322, business negotiation result data 331, and the collected data 341.

The web server program 311 is a program that operates the sales support device 30 as a web server. In the present embodiment, the sales support device 30 functions as a web server by executing the web server program 311 and provides a web page or runs a sales support program 312 or the like in response to a request from the sales terminal 10 which is a web client.

The sales support program 312 is a program for realizing the sales support function according to the present invention. The sales support device 30 performs a process of providing various web pages to the sales terminal 10 by referring to the problem organization database 321 and various table groups 322 by executing the sales support program 312, and acquire and store the business negotiation result data 331 input by the sales staff.

The weighting processing program 313 is a program for setting a weighting value in the problem organization database 321. By executing the weighting processing program 313, the sales support device 30 can set a weighting value for the problem organization database 321 based on the business negotiation result data 331, the collected data 341, and the like.

The collected data analysis program 314 is a program for analyzing the collected data 341 provided from the site survey terminal 20. As an example, the collected data analysis program 314 includes a text data analysis program 3141 that extracts words from text data 3411, a voice text conversion program 3142 that converts audio data 3412 into text data 3411, and an image analysis program 3143 that detects an object (shot object) from the image data 3413. Further, a deep learning program 3144 capable of extracting features of complex information included in text data 3411, audio data 3412, image data 3413, and the like, by a deep learning technique may be included.

The problem organization database 321 is a database constructed in consideration of a series of flows in business negotiations. The problem organization database 321 is a database constructed by analyzing problems from past cases such as huge sales results and business negotiations and based on the analysis results. As an example, the problem organization database 321 has a configuration in which management goals, problems/measures, and solutions are hierarchically arranged. The details of the problem organization database 321 will be described later.

The various table groups 322 represent a plurality of tables storing various settings related to the problem organization database 321 including a weighting table for each company category storing weighting values related to the problem organization database 321. The various table groups 322 include a scenario table, a case management table, a company classification table, a weighting table for each company classification, an existing word dictionary/weighting table, an object list table, an existing object dictionary/weighting table, and the like, which will be described later.

The business negotiation result data 331 is the business negotiation result data input on the sales terminal 10. The business negotiation result data 331 includes various information related to business negotiations conducted by the sales staff with respect to each company, and includes, for example, text data, audio data, and image data. The sales support device 30 can analyze the business negotiation result data 331 by executing the collected data analysis program 314, and can update the weighted value for the problem organization database 321 based on the analysis result.

The collected data 341 is the collected data 213 collected by the site survey terminal 20. The collected data 341 includes various information related to the site survey conducted by the site surveyor, and includes, for example, text data 3411, audio data 3412, and image data 3413 as shown in FIG. 4. The sales support device 30 can analyze the collected data 341 by executing the collected data analysis program 314, and can update the weighted value for the problem organization database 321 based on the analysis result.

FIG. 4 shows a state in which a plurality of programs and a plurality of data are stored in one storage 306, but each program and each data may be distributed to a plurality of devices. For example, a device for managing a problem organization database 321 and various table groups 322, a device for managing business negotiation result data, and a device for managing collected data are distributed on a network such as an in-house LAN, and are sales support devices. 30 may appropriately acquire necessary data from these devices.

<Functions of Sales Support System>

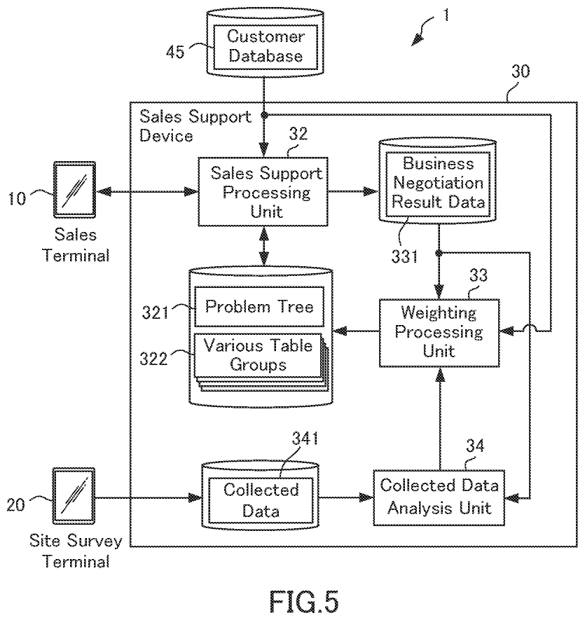

The functions of the sales support system 1 in the embodiment of the present invention will be described with reference to FIG. 5. FIG. 5 is a functional block diagram showing an example of the functions of the sales support system 1 according to the embodiment of the present invention. The sales support system 1 according to the present invention is not limited to the functions shown in FIG. 5.

The sales support device 30 has the functions of the sales support processing unit 32, the weighting processing unit 33, and the collected data analysis unit 34.

The sales support processing unit 32 is a function embodied by executing the sales support program 312. The sales support processing unit 32 is configured to provide sales support to the sales terminal 10. The sales support processing unit 32 can read the company information of a specific company from the customer database 45 and provide the same to the sales terminal 10 in response to the request from the sales terminal 10. The sales support processing unit 32 refers to the problem organization database 321 and various table groups 322 in response to the request from the sales terminal 10, processes the information contained in the problem organization database 321 and can provide the information to the sales terminal 10. Further, the sales support processing unit 32 can receive the data input by the sales staff on the sales terminal 10 and store the inputted data as the business negotiation result data 331. Further, the sales support processing unit 32 reconstructs the problem organization database 321 (for example, editing nodes and edges to be described later), and cooperates with the weighting processing unit 33 to reset various table groups 322 (for example the weighting value set for the problem organization database 321 can be changed).

The weighting processing unit 33 is a function embodied by executing the weighting processing program 313. The weighting processing unit 33 can change the weighting value set for the problem organization database 321 based on the company information, the business negotiation result data 331, and the analysis result by the collected data analysis unit 34. Further, the weighting processing unit 33 can cooperate with the collected data analysis unit 34 to cause the collected data analysis unit 34 to appropriately analyze the text, sound, and image included in the business negotiation result data 331 and the collected data 341.

The collected data analysis unit 34 is a function embodied by executing the collected data analysis program 314. The collected data analysis unit 34 can analyze the text, voice, and image contained in the business negotiation result data 331 and the collected data 341, and weights the analysis result including the word contained in the text and voice, and can provide the object contained in the image, and the like to the weighting processing unit 33.

<Problem Organization Database>

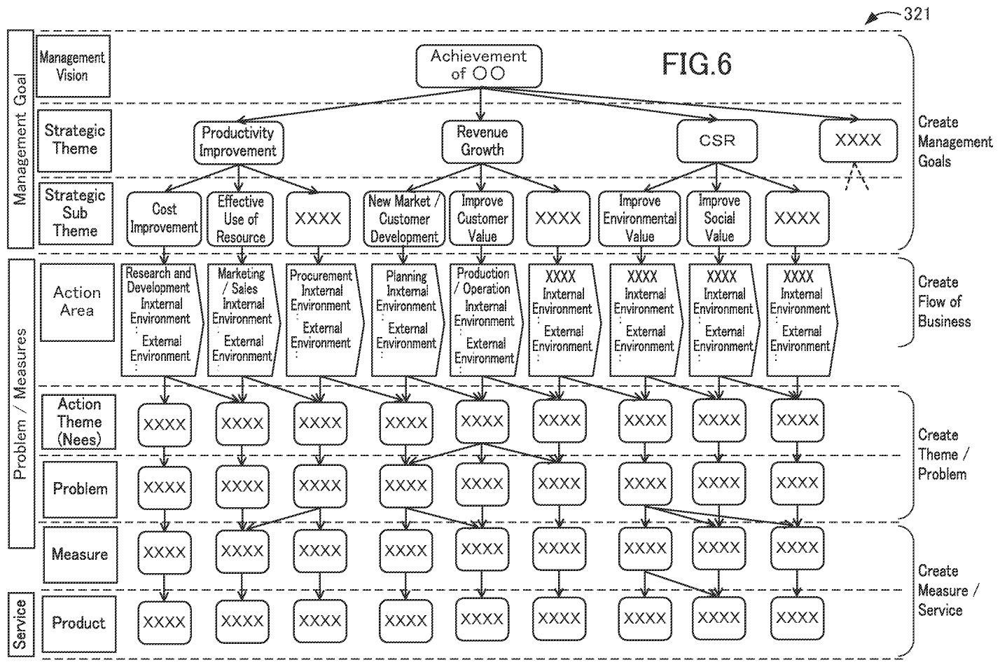

The concept of the problem organization database 321 in the present embodiment will be described with reference to FIG. 6. FIG. 6 is a schematic diagram showing the concept of the problem organization database 321 according to the embodiment of the present invention.

Normally, when proposing a product (service) to a company that is a customer, it is considered what kind of problem the customer has and what kind of product he/she is looking for. As an example, the flow of the examination can be divided into four processes: management goal creation, business flow creation, theme/problem creation, and policy/service creation.

In the management goal creation, which is the first process, for example, the work of investigating the customer's financial results briefing materials and organizing the customer's management vision, theme, sub-theme, and the like is performed. In the second step of creating a business flow, the work of dividing the customer's business activities into areas and organizing the business environment in each area is performed. In the theme/problem creation, which is the third process, work is performed to specify a specific theme/problem according to the business environment of the customer. In the fourth step, the work of organizing the measures for solving the specified themes and problems and identifying the services that contribute to the measures is performed.

The problem organization database 321 in this embodiment is constructed according to the above-mentioned examination flow. Specifically, as shown in FIG. 6, in the problem organization database 321, management goals, problems/measures, and services are arranged hierarchically, and the upper layer and the lower layer are appropriately related.

At the top of the problem organization database 321 is a hierarchy of management goals. The hierarchy of management goals is composed of each hierarchy of management vision, strategic theme, and strategic sub-theme.

The hierarchy of the management vision clarifies the future image of the company to realize the goals and management philosophy of the company that is the customer. The hierarchy of strategic themes embodies the points for strengthening the company and the goals that the company should work on in order to realize the management vision. The hierarchy of strategic sub-themes is a further embodiment of the strategic theme.

With the above configuration, in the hierarchy of management goals, it is possible to specify the strategic theme from the management vision and further specify the strategic sub-theme.

The hierarchy of problems/measures is placed below the hierarchy of management goals. The hierarchy of problems/measures is composed of each hierarchy of action areas, action themes (needs), problems, and measures.

The hierarchy of the action area is a classification of departments and businesses (tasks) for realizing the goals embodied in the strategic sub-theme. In the hierarchy of the action area, the business flow (value chain) can be specified.

The hierarchy of the action theme is a further classification of the business contents in the hierarchy of the action area. In the hierarchy of the action theme, more specific business contents can be classified for the business contents specified in the hierarchy of the action area.

The problem hierarchy is a classification of specific problems related to the business content specified in the action theme hierarchy. The measure hierarchy is a classification of solutions for solving the problems specified in the problem hierarchy.

With the above configuration, in the hierarchy of problems/measures, the action area is specified from the strategic sub-themes specified in the management goal hierarchy, the action theme is specified from the action area, the problem is specified from the action theme, and the measure is specified from the problem. It should be noted that the layer above the problem hierarchy corresponds to a series of processes for deriving the problem, and can be said to be a layer including the problem derivation item for deriving the problem. In the example of FIG. 6, the hierarchy of the management vision, the strategic theme (including the strategic sub-theme), the action area (value chain), and the action theme is the layer including the problem derivation item, and the problem is derived through the layer including the problem derivation item.

The service hierarchy is located below the problem/measure hierarchy. In the service hierarchy, specific solutions (services that are products) corresponding to the measures are associated. As a result, in the service hierarchy, it is possible to specify the service for realizing the measures specified in the problem/measure hierarchy.

The problem organization database 321 is composed of a plurality of layers as described above, and each layer includes a plurality of nodes (also referred to as components or elements). The nodes of each layer are connected to the nodes included in the adjacent upper layer and lower layer by an edge (also called a link) indicating the relationship between the nodes. In particular, the nodes included in the middle layer excluding the layer of the management vision at the top layer and the layer of services at the bottom layer are connected to both the adjacent upper layer and lower layer nodes by edges.

The edge connects nodes that are highly related to each other. Specifically, it is preferable that the nodes corresponding relationship based on various knowledge such as a strategic theme corresponding to a specific management vision, an action theme corresponding to a specific strategic theme, a problem that may occur in a specific action theme, a measure that can solve a specific problem, a specific measure that can be realized, and a service that can realize the specific measure.

With this configuration, in the problem organization database 321 in the present embodiment, it is possible to follow from the upper layer to the lower layer by drilling down, and the hierarchical structure is created while selecting the lower layer nodes starting from the uppermost node, thereby making it possible to descend the hierarchy to reach the lowest node.

In the present embodiment, as described above, the problem organization database 321 has a hierarchical structure, and it is possible to select a plurality of nodes in the lower layer in each hierarchy. As will be described later, when the sales staff selects one or more nodes in a certain hierarchy, the display screen of the sales terminal 10 displays all the nodes in the lower layer connected to the selected plurality of nodes. The sales staff can finally identify a plurality of services to be proposed to the customer while appropriately selecting a plurality of problems and a plurality of measures.

In the problem organization database 321 having a hierarchical structure, there are a plurality of routes from the top layer node to the bottom layer node by tracing the middle layer. In the present embodiment, it is possible to set a weighted value for each of such a plurality of routes, that is, for each route. The weighted value is not arbitrarily set by the user, and as will be described later, for company attributes (including company industry classification, scale, listing classification, region, and the like), negotiation status, and similar companies. It is set based on the history (business negotiation result data for similar companies) and the like. The display order of the services is determined based on the weighted value, and the services are displayed on the display screen of the sales terminal 10 based on the display order.

The problem organization database 321 shown in FIG. 6 is only an example of the problem organization database used in the present embodiment, and the type and number of layers provided in the problem organization database 321 can be arbitrarily set as appropriate. Further, the problem organization database 321 is not particularly limited as long as it has a hierarchical structure capable of reaching the lowest layer node from the uppermost layer node. The problem organization database 321 may be, for example, a directed tree (directed tree) type database in which the edges are directed from the upper layer to the lower layer, and the nodes in the lower layer become a plurality of nodes in the upper layer. Or, it may be a connected directed non-circular graph type database.

<Weighted Value for Each Scenario>

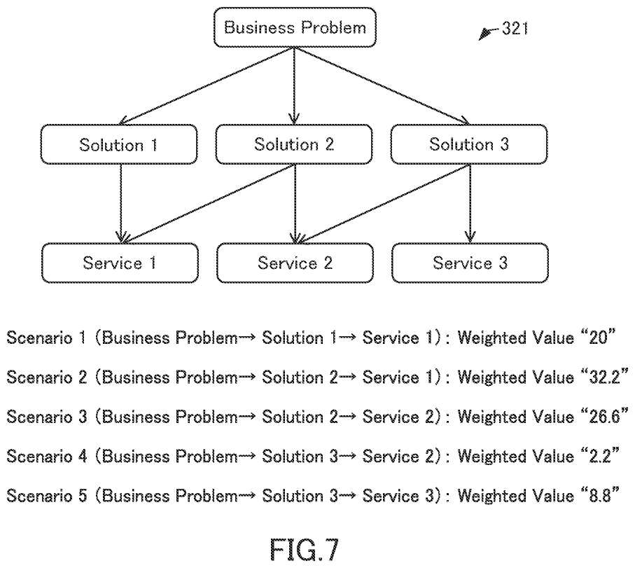

With reference to FIG. 7, the weighted values set in the problem organization database 321 in the present embodiment will be described. FIG. 7 is a diagram for explaining the concept of weighting for the problem organization database 321 in the embodiment of the present invention.

FIG. 7 shows a part of the problem organization database 321 of FIG. 6. Here, for the sake of explanation, a plurality of layers are grouped into one layer for simplification. In the simplified problem organization database 321 of FIG. 7, there are shown the node of the upper layer “Business Problem”, the three nodes of the middle layer “Solution 1”, “Solution 2”, and “Solution 3”, and the three nodes of the lower layer “Service 1”, “Service 2”, and Service 3”.

The node of “Business problem” is connected to three nodes of “Solution 1”, “Solution 2”, and “Solution 3”. One of the three nodes “Solution 1”, “Solution 2”, and “Solution 3” can be selected from the “Business Problem” node. The node of “Solution 1” is connected to the node of “Service 1”. The node of “Solution 2” is connected to two nodes of “Service 1” and “Service 2”. The node of “Solution 3” is connected to two nodes of “Service 2” and “Service 3”.

In this specification, the route from the node of the upper layer to the node of the lower layer via the middle layer may be described as “scenario. The scenario corresponds to a series of flows from the sales staff to the decision of the service from the business problem at the time of negotiation. The layer that is the starting point of the scenario can be any layer, and for example, the layer of the strategic theme located at the top of the problems/measures can be the layer that is the starting point of the scenario. Further, the layer that is the end point of the scenario can be any layer, but it is preferable that the layer is the layer of the service (product) located at the lowest layer.

In the simplified problem organization database 321 shown in FIG. 7, there exist five different nodes (scenarios 1-5) from the upper layer “business problem” node to the lower layer “Service 1”, “Service 2”, and “Service 3” nodes. Scenario 1 is a route that follows each node of “business problem”, “solution 1”, and “Service 1”. Scenario 2 is a route that follows each node of “business problem”, “Solution 2”, and “Service 1”. Scenario 3 is a route that follows each node of “business problem”, “Solution 2”, and “Service 2”. Scenario 4 is a route that follows each node of “business problem”, “Solution 3”, and “Service 2”. Scenario 5 is a route that follows each node of “business problem”, “Solution 3”, and “Service 3”.

Weighted values are set for each of scenarios 1 to 5. In the example shown in FIG. 7, scenario 1 has a weighted value of “20”, scenario 2 has a weighted value of “32.2”, scenario 3 has a weighted value of “26.6”, and scenario 4 has a weighted value of “26.6”. It is assumed that the value “2.2” and the weighting value “8.8” are set in the scenario 5. The weighted value indicates that the higher the value, the higher the priority of the scenario.

In the simplified problem organization database 321 shown in FIG. 7, assume that the sales staff selects “Business Problem”, and “Solution 1”, “Solution 2”, and “Solution 3” associated with the “Business Problem”. In this case, “Service 1”, “Service 2”, and “Service 3” associated with “Solution 1”, “Solution 2”, and “Solution 3” are displayed on the display screen of the sales terminal 10. It is displayed with the display priority based on the weighted value of the scenario. A specific display example on the display screen of the sales terminal 10 will be described later.

The method of determining the display priority based on the weighted value is not particularly limited. For example, the sum of the weighted values related to each of “Service 1”, “Service 2”, and “Service 3” may be calculated and the sum may be compared. In the above example, the sum of the weighted values related to “Service 1” is “52.2”, the sum of the weighted values related to “Service 2” is “28.8”, and the sum of the weighted values related to “Service 3” is “28.8”. The total sum is “8.8”, and the display priority is “Service 1”, “Service 2”, and “Service 3” in that order. Alternatively, the maximum value of the weighted values related to each of “Service 1”, “Service 2”, and “Service 3” may be selected and compared. In the above example, the maximum value of the weighted value related to “Service 1” is “32.2”, the maximum value of the weighted value related to “Service 2” is “26.8”, and the maximum value of the weighted value related to “Service 3” is “Service 3”. The maximum value of the assigned value is “8.8”, and even in this case, the display priority is “Service 1”, “Service 2”, and “Service 3” in that order.

As another example, in the simplified problem organization database 321 shown in FIG. 7, it is assumed that the sales staff selects “business problem” and only “Solution 3” associated with “business problem”. In this case, on the display screen of the sales terminal 10, “Service 2” and “Service 3” associated with “Solution 3” are displayed with display priorities based on the weighted values of each scenario. The scenarios related to “Solution 3” are scenario 4 and scenario 5, and the display priority based on the weighted value is “Service 3” and “Service 2” in that order.

The display mode that reflects the display priority is not particularly limited, and for example, the display may be arranged side by side from left to right (or from top to bottom) on the display screen in order from the one with the highest display priority. Further, the higher the weighting value, the more the color or shading may be used for highlighting, and the higher the weighting value, the larger the display screen may be.

The sales staff can grasp the order determined by the weighted value by referring to the display reflecting the display priority. However, the final proposal to the customer by the sales staff is not bound by this display priority. For example, in the above alternative example, “Service 3” and “Service 2” are displayed in this order, but when it can be determined that “Service 2” is selected more than “Service 3”, “Service 2” may be proposed to the customer.

Further, the weighting value set for each scenario may be set to be a different numerical value according to the corporate attributes such as the type of business (industry classification) of the company proposing the service and the size of the company. Companies in different industries, or companies in the same industry but different in scale, tend to have significantly different management goals, problems faced by the company, and measures and services to solve those problems. In other words, for example, companies with the same corporate attributes tend to have similar management goals, problems, and measures and services for solving the problems. In consideration of this point, by setting different weighting values according to the company attributes, it becomes possible to raise the display priority of the service suitable for each company. In this embodiment, an example of using a company's industry (industry classification) or company size as a company attribute will be mainly described, but the company attribute may be an arbitrary condition in which each company can be classified. Specifically, as corporate attributes, in addition to the type of business (industry category) and size of the company, the sales increase rate and ordinary income growth rate calculated from the listing category, region (including country), financial statements, and the like. Labor productivity and the like can be used. Similar companies and dissimilar companies can be classified according to each of these conditions, the same weight value can be set for similar companies, and different weight values can be set for dissimilar companies.

Further, in the problem organization database 321 having a hierarchical structure as described above, there are a plurality of routes from the uppermost node to the lowermost node by tracing the middle layer. In the present embodiment, it is possible to set a weighted value for each of such a plurality of routes, that is, for each route. In addition, as will be described later, the weighted values include company attributes (including company industry classification, scale, listing classification, region, and the like), negotiation status, and history of service applied to similar companies (similar companies). It is set based on the business negotiation result data) and so on. The sales support device 30 determines the display order of services based on the weighted value, and can display the services on the display screen of the sales terminal 10 based on the display order.

<Specific Example of Display Screen on Business Terminal>

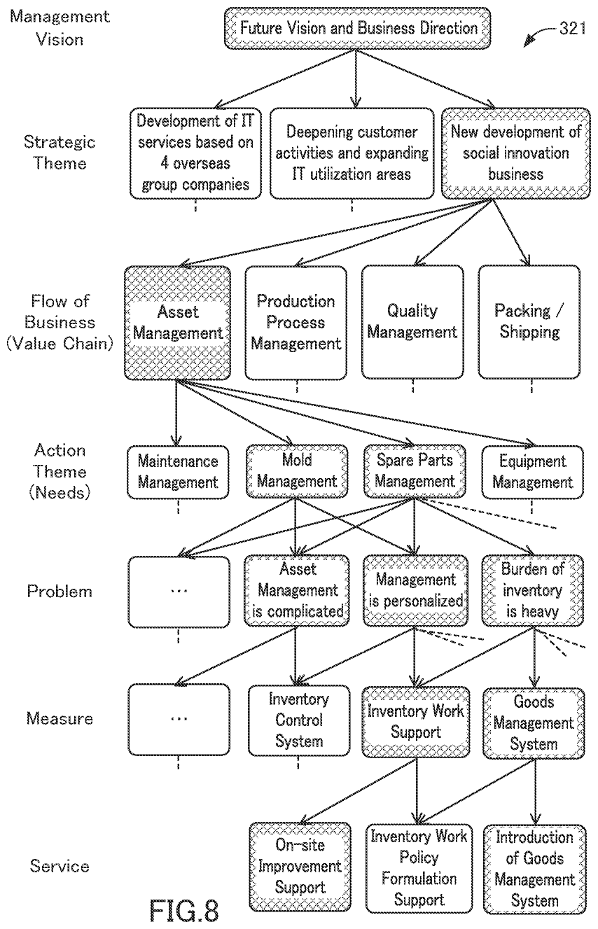

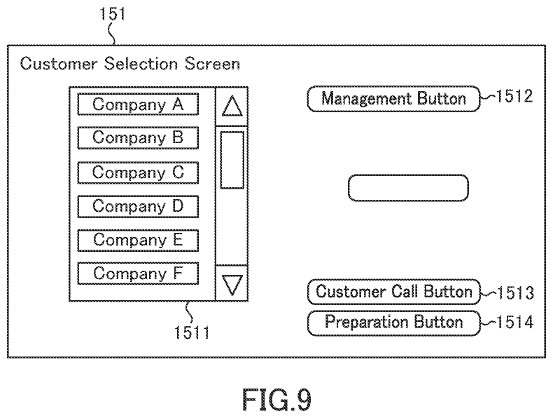

A specific operation example in this embodiment will be described with reference to FIGS. 8 to 17. FIG. 8 is a diagram showing a part of the problem organization database 321 used for explaining a specific operation example in the present embodiment. FIGS. 9 to 17 show a customer selection screen 151, a business goal selection screen 152, a business flow selection screen 153, an action theme selection screen 154, a problem selection screen 155, a measure selection screen 156, a service selection screen is 157, an optimum solution proposal screen is 158, and a business negotiation result registration screen 159 displayed on the display screen of the sales terminal 10, respectively.

Hereinafter, with reference to FIGS. 9 to 17, the transition of the display screen in which the sales staff browses and inputs operations at the time of business negotiation will be described. Here, it is assumed that the problem organization database 321 has the configuration shown in FIG. 8. The problem organization database 321 shown in FIG. 8 is composed of each layer of management vision, strategic theme, business flow (value chain), action theme (needs), problem, measure, and service. Further, among the nodes between the layers adjacent to each other above and below, the nodes having high mutual relations are related in advance by the edge.

The sales staff accesses the sales support device 30 using the sales terminal 10 at the time of business negotiations with customers. Specifically, the sales staff can access the sales support device 30 by designating an address (URL) for using the sales support function implemented in the sales support device 30 on the web browser of the sales terminal 10.

The relationship between the sales terminal 10 and the sales support device 30 is the same as that of a normal web system. The sales terminal 10 makes a request to the sales support device 30, and the sales support device 30 performs processing according to the request and responds to the sales terminal 10. The sales terminal 10 displays data such as a web page received from the sales support device 30 on a web browser, so that the sales staff can browse the display screen and perform an operation for the next request.

When conducting a business negotiation with a customer, the sales staff proceeds with the business negotiation while browsing the display screen of the sales terminal 10. When the sales support device 30 is accessed from the sales terminal 10, the sales support device 30 may first provide a login page to the sales terminal 10. The sales staff can be authenticated by the user ID and password entered on the login page.

If the sales staff authentication is successful, the customer selection screen 151 shown in FIG. 9 is displayed on the monitor 105 of the sales terminal 10. The customer selection screen 151 has a customer list display area 1511 for displaying a list of customers, a management button 1512, a customer call button 1513, and a preparation button 1514.

A company list is displayed in the customer list display area 1511, and the sales staff can select a company that is a business partner from this company list.

The management button 1512 is a button for instructing the transition to the management screen. Although detailed description of the management screen is omitted, the management screen allows editing of the problem organization database 321 (for example, addition, deletion, change, and the like of nodes and edges).

The customer call button 1513 is a button for instructing the transition to the management goal selection screen.

The preparation button 1514 is a button for instructing the transition to the preparation screen. The detailed explanation of the advance preparation screen is omitted, but on the advance preparation screen, it is possible to browse the company information and the like related to each company obtained by the advance research.

On the customer selection screen 151, the sales staff selects a company to be negotiated from the company list displayed in the customer list display area 1511 and presses the customer call button 1513.

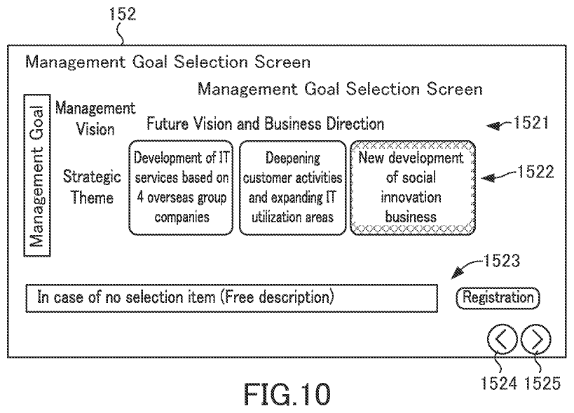

The sales support device 30 reads company information (customer information) about the selected company from the customer database 45, and provides data (for example, a web page) for displaying the management target selection screen 152 to the sales terminal 10. The management goal selection screen 152 shown in FIG. 10 is displayed on the monitor 105 of the sales terminal 10.

The management goal selection screen 152 has a management vision display area 1521, a strategic theme display area 1522, a free description area 1523, a back button 1524, and a forward button 1525.

In the management vision display area 1521, the management vision of the customer specified from the company information is displayed.

In the strategy theme display area 1522, all the strategy themes connected to the management vision at the edge are displayed in the problem organization database 321. If there are many strategic themes, the display in the strategic theme display area 1522 may be scrolled so that all strategic themes can be confirmed. Further, the strategy theme displayed in the strategy theme display area 1522 is displayed so as to be selectable, and the sales staff can select one or a plurality of strategy themes.

In the free description area 1523, a text input area and a registration button that can be freely described by the sales staff are displayed. If the appropriate strategic theme does not exist in the strategic theme display area 1522, the sales staff may set a new strategic theme as appropriate. When the sales staff describes the information about the new strategy theme in the text input area and presses the registration button, the new strategy theme is displayed in the strategy theme display area 1522. When the new strategic theme is added, the sales support device 30 may add the new strategic theme to the problem organization database 321.

The back button 1524 is a button for instructing a transition to the immediately preceding display screen (customer selection screen 151), and the forward button 1525 is a button for instructing a transition to the next display screen (business flow selection screen 153).

The sales staff interviews the customer, selects one or more strategic themes that match the actual situation of the customer from the strategic themes displayed in the strategic theme display area 1522, and presses the forward button 1525. Here, it is assumed that one strategic theme, “new development of social innovation business,” is selected. The items selected by the sales staff are shaded in FIG. 10.

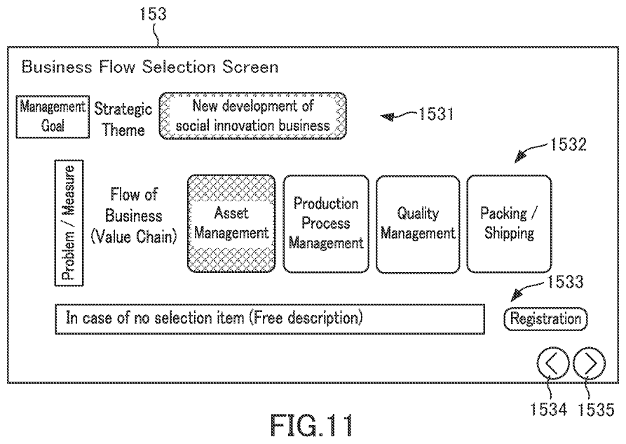

The sales support device 30 provides the sales terminal 10 with data (for example, a web page) for displaying the business flow selection screen 153 based on the selected strategic theme. The business flow selection screen 153 shown in FIG. 11 is displayed on the monitor 105 of the sales terminal 10.

The business flow selection screen 153 has a selection history display area 1531, a business flow display area 1532, a free description area 1533, a back button 1534, and a forward button 1535.

In the selection history display area 1531, the items (selection history) selected by the sales staff up to the business flow selection screen 153 are displayed. The sales staff can confirm the items selected so far by referring to the selection history display area 1531. When a large number of display items exist in the selection history display area 1531, the display may be scrollable, so that the display may be reduced or simplified.

In the business flow display area 1532, all business flows (value chains) connected to the selected strategic theme at the edge in the problem organization database 321 are displayed. When there are a large number of business flows (value chains), the display in the business flow display area 1532 may be scrolled so that all business flows (value chains) can be confirmed. In addition, the business flow (value chain) displayed in the business flow display area 1532 is displayed so as to be selectable, so that the sales staff can select one or more business flows (value chain).

In the free description area 1533, a text input area and a registration button that can be freely described by the sales staff are displayed. Similar to the free description area 1523 of the management target selection screen 152 described above, the sales staff can set a new business flow (value chain) in the free description area 1533.

The back button 1534 is a button for instructing the transition to the immediately preceding display screen (management target selection screen 152), and the forward button 1535 is instructing the transition to the next display screen (approach theme selection screen 154).

The sales staff conducts interviews with the customer, and from the business flow (value chain) displayed in the business flow display area 1532, one or more business flows (value) that match the actual situation of the customer. Select the chain and press the forward button 1535. Here, it is assumed that one business flow (value chain) “asset management” is selected. The items selected by the sales staff are shaded in FIG. 11.

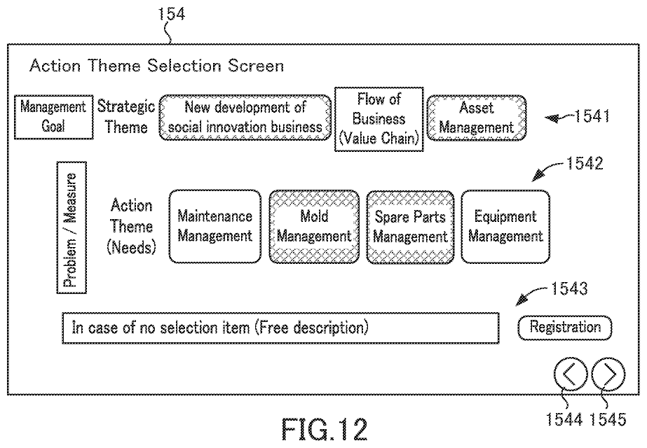

The sales support device 30 provides the sales terminal 10 with data (for example, a Web page) for displaying the action theme selection screen 154 based on the selected business flow (value chain). The approach theme selection screen 154 shown in FIG. 12 is displayed on the monitor 105 of the sales terminal 10.

The action theme selection screen 154 has a selection history display area 1541, an action theme display area 1542, a free description area 1543, a back button 1544, and a forward button 1545.

In the selection history display area 1541, the items (selection history) selected by the sales staff up to the action theme selection screen 154 are displayed. The sales staff can confirm the items selected so far by referring to the selection history display area 1541. When a large number of display items exist in the selection history display area 1541, the display may be scrollable, and the display may be reduced or simplified.

In the action theme display area 1542, all the action themes (needs) connected to the selected business flow (value chain) at the edge in the problem organization database 321 are displayed. When there are many action themes (needs), the display in the action theme display area 1542 may be scrolled so that all the action themes (needs) can be confirmed. In addition, the action theme (needs) displayed in the action theme display area 1542 is displayed so as to be selectable, and the sales staff can select one or more action themes (needs).

In the free description area 1543, a text input area and a registration button that the sales staff can be freely describe are displayed. Similar to the free description area 1523 of the management goal selection screen 152 described above, the sales staff can set a new approach theme (needs) in the free description area 1543.

The back button 1544 is a button for instructing a transition to the immediately preceding display screen (business flow selection screen 153), and the forward button 1545 is a button for instructing a transition to the next display screen (problem selection screen 155).

The sales staff interviews the customer and selects one or more action themes (needs) that match the actual situation of the customer from the action themes (needs) displayed in the action theme display area 1542. Press the forward button 1545. Here, it is assumed that two action themes (needs) “mold management” and “spare parts management” are selected. The items selected by the sales staff are shaded in FIG. 12.

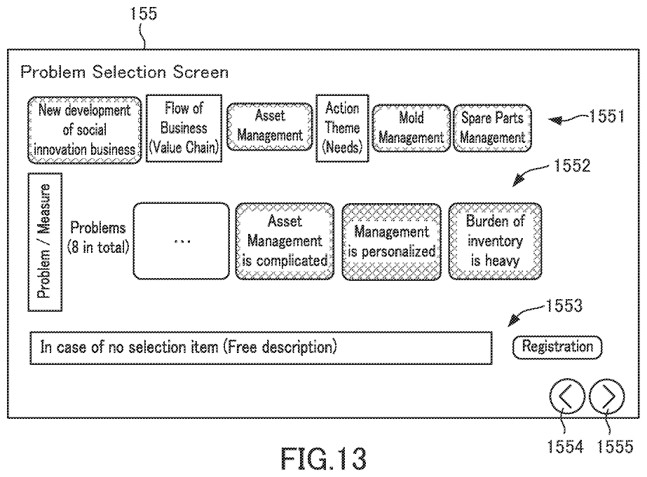

The sales support device 30 provides the sales terminal 10 with data (for example, a web page) for displaying the problem selection screen 155 based on the selected action theme (needs). The problem selection screen 155 shown in FIG. 13 is displayed on the monitor 105 of the sales terminal 10.

The problem selection screen 155 has a selection history display area 1551, a problem display area 1552, a free description area 1553, a back button 1554, and a forward button 1555.

In the selection history display area 1551, the items (selection history) selected by the sales staff up to the problem selection screen 155 are displayed. The sales staff can confirm the items selected so far by referring to the selection history display area 1551. When a large number of display items exist in the selection history display area 1551, the display may be scrollable, and the display may be reduced or simplified.

In the problem display area 1552, all the problems connected by the edge to the selected action theme in the problem organization database 321 are displayed. When there are a large number of problems, the display in the problem display area 1552 may be scrolled so that all the problems can be confirmed. Further, the problems displayed in the problem display area 1552 are displayed so as to be selectable, and the sales staff can select one or a plurality of problems.

In the free description area 1553, a text input area and a registration button that can be freely described by the sales staff are displayed. Similar to the free description area 1523 of the management goal selection screen 152 described above, the sales staff can set a new problem in the free description area 1553.

The back button 1554 is a button for instructing a transition to the immediately preceding display screen (action theme selection screen 154), and the forward button 1555 is a button for instructing a transition to the next display screen (measure selection screen 156).

The sales staff interviews the customer, selects one or more problems that match the actual situation of the customer from the problems displayed in the problem display area 1552, and presses the button 1555 to proceed. Here, it is assumed that three problems, “asset management is complicated”, “management is personalized”, and “inventory burden is heavy” are selected. The items selected by the sales staff are shaded in FIG. 13.

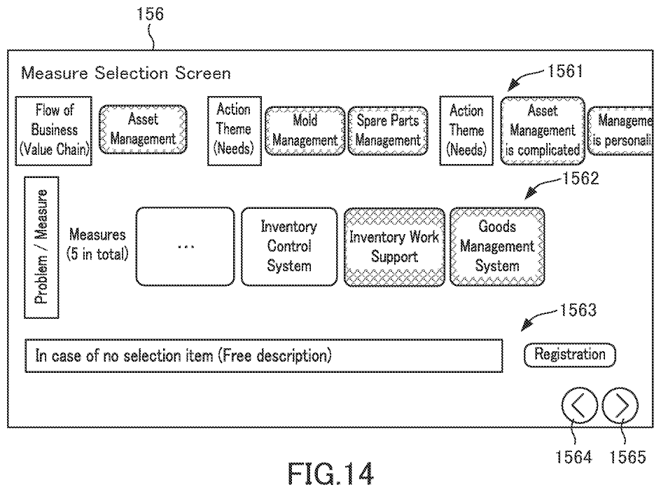

The sales support device 30 provides the sales terminal 10 with data (for example, a web page) for displaying the measure selection screen 156 based on the selected problem. The measure selection screen 156 shown in FIG. 14 is displayed on the monitor 105 of the sales terminal 10.

The measure selection screen 156 has a selection history display area 1561, a measure display area 1562, a free description area 1563, a back button 1564, and a forward button 1565.

In the selection history display area 1561, the items (selection history) selected by the sales staff up to the measure selection screen 156 are displayed. The sales staff can confirm the items selected so far by referring to the selection history display area 1561. When a large number of display items exist in the selection history display area 1561, the display may be scrollable, and the display may be reduced or simplified.

In the measure display area 1562, all the measures connected to the selected problem at the edge in the problem organization database 321 are displayed. When there are many measures, the display in the measure display area 1562 may be scrolled so that all the measures can be confirmed. Further, the measures displayed in the measure display area 1562 are displayed so as to be selectable, and the sales staff can select one or a plurality of measures.

In the free description area 1563, a text input area and a registration button that can be freely described by the sales staff are displayed. Similar to the free description area 1523 of the management target selection screen 152 described above, the sales staff can set a new measure in the free description area 1563.

The back button 1564 is a button for instructing a transition to the immediately preceding display screen (problem selection screen 155), and the forward button 1565 is a button for instructing a transition to the next display screen (service selection screen 157).

The sales staff interviews the customer, selects one or more measures that match the actual situation of the customer from the problems displayed in the measure display area 1562, and presses the button 1565 to proceed. Here, it is assumed that two problems, “inventory work support” and “goods management systemization”, are selected. The items selected by the sales staff are shaded in FIG. 14.

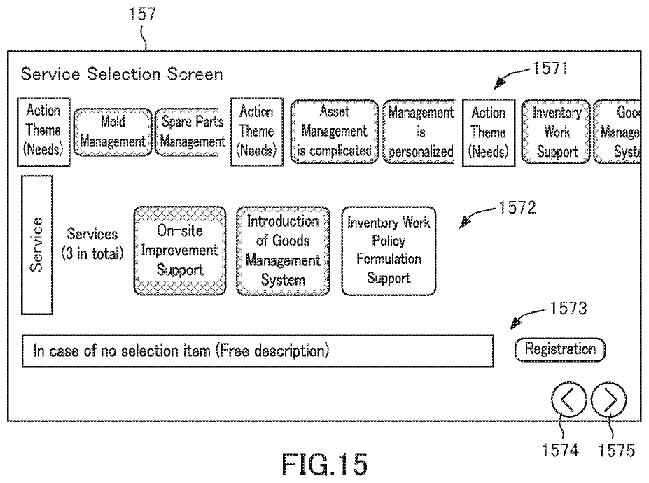

The sales support device 30 provides the sales terminal 10 with data (for example, a web page) for displaying the service selection screen 157 based on the selected measure. The service selection screen 157 shown in FIG. 15 is displayed on the monitor 105 of the sales terminal 10.

The service selection screen 157 has a selection history display area 1571, a measure display area 1572, a free description area 1573, a back button 1574, and a forward button 1575.

In the selection history display area 1571, the items (selection history) selected by the sales staff up to the service selection screen 157 are displayed. The sales staff can confirm the items selected so far by referring to the selection history display area 1571. When a large number of display items exist in the selection history display area 1571, the display may be scrollable, and the display may be reduced or simplified.

In the service display area 1572, all services connected to the selected measure at the edge in the problem organization database 321 are displayed. When a large number of services exist, the display in the service display area 1572 may be scrolled so that all services can be confirmed. Further, the service displayed in the service display area 1572 is displayed so as to be selectable, and the sales staff can select one or a plurality of services.

The service displayed in the service display area 1572 is arranged at the bottom layer of the problem organization database 321 shown in FIG. 8. There are many scenarios (routes) from the top-level management vision to the bottom-level services. The sales support device 30 extracts scenarios that pass only the items (nodes) selected by the sales staff, and as described above with reference to FIG. 7, the service display degree of priority is determined based on the weighted value of each extracted scenario.

Specifically, in the problem organization database 321 shown in FIG. 8, three services “site improvement support”, “inventory work policy formulation support”, and “goods management system installation” are provided for the two problems “inventory work support” and “goods management system” selected by the sales staff. When creating the service selection screen 157, the sales support device 30 identifies all the scenarios that reach these three services from the layer that is the starting point of the scenario (for example, the hierarchy of the strategic theme) via the items selected by the sales staff.

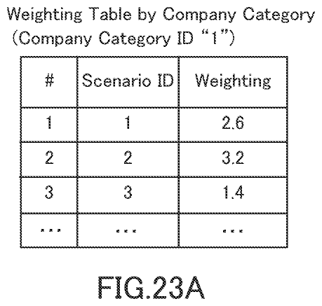

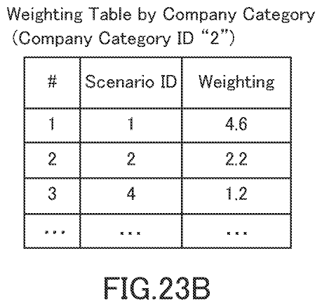

Next, the sales support device 30 reads the weighting values to each scenario with reference to a table corresponding to the company attribute specified from the company information (for example, a weighting table for each company category corresponding to the company industry and company size shown in FIGS. 23A and 23B). Then, based on these weighted values, the display priorities of the three services “site improvement support”, “inventory work policy formulation support”, and “goods management system introduction” are determined, and the services are displayed according to the determined display priorities. The display order of the services in the area 1572 is rearranged.

Here, the service “site improvement support” has the highest display priority, and the service “inventory work policy formulation support” has the lowest display priority. Services with high display priority are placed on the left side of the service display area 1572, and in order of high display priority, from left to right, items of “site improvement support”, “goods management system introduction”, “inventory work policy formulation support” are displayed.

In the free description area 1573, a text input area and a registration button that can be freely described by the sales staff are displayed. Similar to the free description area 1523 of the management target selection screen 152 described above, the sales staff can set a new measure in the free description area 1573.

The back button 1574 is a button for instructing the transition to the immediately preceding display screen (measure selection screen 156), and the forward button 1575 is for instructing the transition to the next display screen (optimal solution proposal screen 158).

The sales staff interviews the customer, selects one or more services that match the actual situation of the customer from the services displayed in the service display area 1572, and presses the forward button 1565. Here, it is assumed that two services, “site improvement support” and “introduction of goods management system”, are selected. The items selected by the sales staff are shaded in FIG. 15.

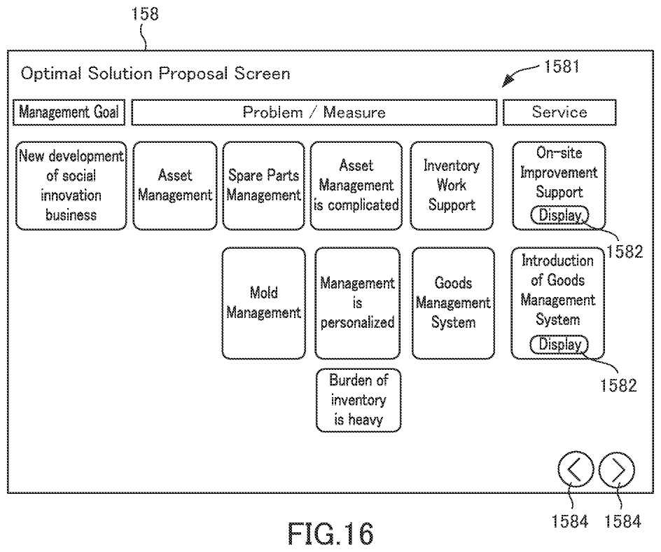

The sales support device 30 provides the sales terminal 10 with data (for example, a web page) for displaying the optimum solution proposal screen 158 based on the selected service. The optimum solution proposal screen 158 shown in FIG. 16 is displayed on the monitor 105 of the sales terminal 10.

The optimum solution proposal screen 158 has a selection history display area 1581, a back button 1584, and a forward button 1585.

By making a series of selections from the management goal selection screen 152 to the service selection screen 157, the sales staff can select service in the problem organization database 321 as shown in FIG. 8 from the top management vision to the bottom layer service, by following the flow of examination. In the selection history display area 1581, each item selected by the sales staff (all the nodes shown by shading in FIG. 8) is collectively displayed in one display screen. By referring to the selection history display area 1581, the sales staff can comprehensively grasp the whole picture of the items selected so far. When a large number of display items exist in the selection history display area 1581, the display may be scrollable, so that the display may be reduced or simplified.

Further, a display button 1582 is provided in the service item displayed in the selection history display area 1581. The display button 1582 is a button for instructing a transition to a screen including detailed information of each service. Services are candidates for products for which proposals to customers should be considered. The sales staff can explain the details of the service to the customer by selecting the display button 1582 and confirming the detailed information of the service.

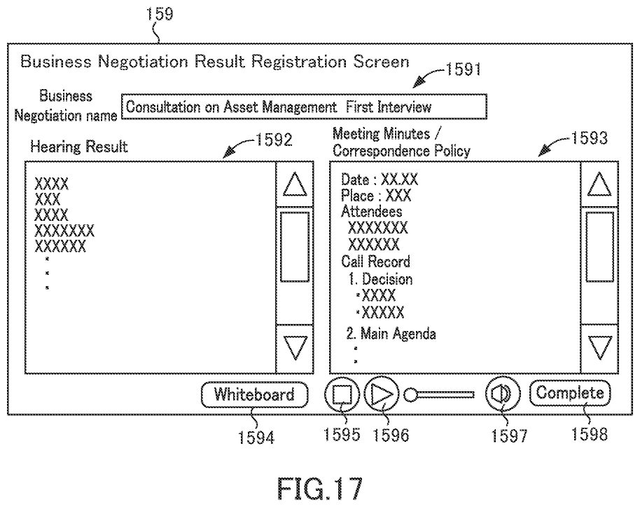

The back button 1584 is a button for instructing the transition to the immediately preceding display screen (service selection screen 157), and the forward button 1585 is for instructing the transition to the next display screen (business negotiation result registration screen 159). When the forward button 1585 is selected, the sales support device 30 provides the sales terminal 10 with data (for example, a web page) for displaying the business negotiation result registration screen 159. The business negotiation result registration screen 159 shown in FIG. 17 is displayed on the monitor 105 of the sales terminal 10.

The business negotiation result registration screen 159 has a negotiation name input area 1591, a hearing result input area 1592, a minutes input area 1593, a whiteboard start button 1594, a record button 1595, a play button 1596, a volume adjustment button 1597, and a completion button 1598.

The opportunity name input area 1591 is a text input area for inputting a title for identifying an opportunity. The hearing result input area 1592 is a text input area for writing down the information obtained at the time of negotiation as a negotiation memo. The minutes input area 1593 is a text input area for describing the minutes and the response policy summarizing the contents of the negotiation.

The whiteboard start button 1594 is a button for instructing the start of a whiteboard application on which figures, characters, and the like can be freely written. The record button 1595, the play button 1596, and the volume adjustment button 1597 are buttons for instructing sound recording, playback, and volume adjustment, respectively.

The business negotiation result registration screen 159 may be appropriately displayed at the time of negotiation as necessary. As a result, the sales staff can input a memo on the business negotiation result registration screen 159. In addition, audio recording/playback and whiteboard activation will be possible in a timely manner.

The completion button 1598 is a button instructing the sales support device 30 to register various information obtained by the negotiation as the business negotiation result data 331.

The sales staff can write down the negotiation memo in the hearing result input area 1592 on the business negotiation result registration screen 159, and can describe the minutes and the response policy in the minutes input area 1593. When the sales staff fills in the necessary information on the business negotiation result registration screen 159 and presses the completion button 1598, the sales support device 30 selects at the time of the negotiation together with the negotiation memo, the minutes, and the response policy described on the business negotiation result registration screen 159. The created scenario (selection history displayed on the optimum solution proposal screen 158) is saved as the business negotiation result data 331 related to the company.

As shown in the above specific example, in the present embodiment, in the problem organization database 321 having a hierarchical structure constructed based on the flow of examination performed at the time of negotiation, the lower layer node associated with the upper layer node can be displayed. Furthermore, it is possible to select multiple nodes from the many displayed nodes, and when multiple nodes are selected, all the nodes in the lower layer associated with the multiple items are displayed. This makes it possible to drill down the problem organization database 321 while selecting multiple nodes, and it is possible to identify services suitable for customers while fully considering multiple problems and multiple measures. The layer above the problem hierarchy corresponds to a series of processes for deriving the problem. In the example of FIG. 8, the hierarchy of the management vision, the strategic theme, the business flow (value chain), and the action theme is the layer including the problem derivation item, so that the problem can be derived through the layer including the problem derivation item.

Further, as shown in the above specific example, in the present embodiment, the items selected in the upper layer can be displayed as the selection history on the display screen displaying the items in the predetermined layer. In this embodiment, since it is possible to select a plurality of nodes in particular, it is effective to be able to immediately confirm what kind of node is selected in the upper layer.

Further, as shown in the above specific example, in the present embodiment, all the nodes from the top layer to the bottom layer selected by the sales staff can be displayed as shown in the optimum solution proposal screen 158 shown in FIG. 16. In the present embodiment, since it is possible to select a plurality of nodes in particular, it is effective to be able to comprehensively grasp the whole picture of the selected nodes in the problem organization database 321.

<Processing Related to Weighting>

Hereinafter, the processing related to weighting will be explained. In addition, various table groups 322 required for processing related to weighting will be appropriately described.

The sales support device 30 can set a weighted value for the scenario of the problem organization database 321 from the company information and the information directly obtained from the customer.

As the company information to be referred to when performing the weighting value, for example, the company attributes such as the industry classification, scale, listing classification, and region of the company can be used. The sales support device 30 can propose an appropriate service according to the company attribute by setting a different weighting value for each company attribute. In addition, companies with the same company attributes can be regarded as similar companies, and weighted values can be set using the past application history to similar companies. Further, the sales support device 30 can also set a weighted value according to the progress of business negotiations with each company.

Further, as the information directly obtained from the customer, for example, the business negotiation result data or the collected data by the on-site survey can be used. The business negotiation result data includes text data such as negotiation memos, minutes, and response policies, and the collected data includes text data, audio data, and image data obtained in the site survey. The sales support device 30 can improve the accuracy of the weighted value by reflecting the analysis result of these data in the weighted value.

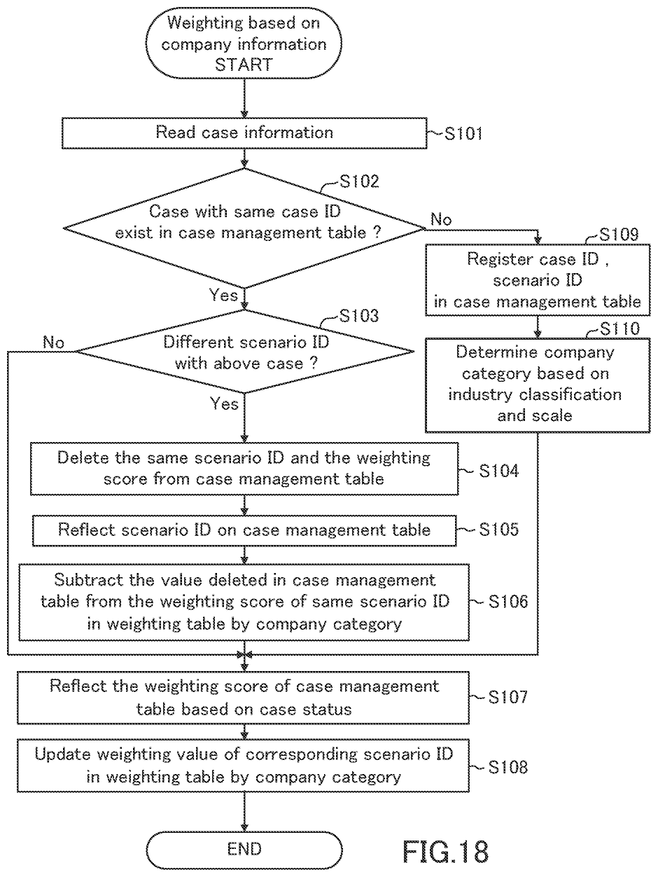

The process of setting the weighted value from the company information will be described with reference to FIG. 18. FIG. 18 is a diagram showing an example of a weighted value setting process from company information in the present embodiment. The weighted value setting process according to the present invention is not limited to the process shown in FIG. 18.

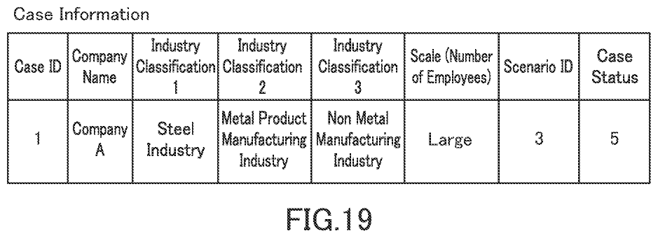

As shown in FIG. 18, the sales support device 30 reads the case information of the specific case ID from the case table (step S101). The case table is a table for managing case information about each company. The sales support device 30 reads the case information of a specific case ID as shown in FIG. 19, for example.

FIG. 19 is an example of the case information referred to in this embodiment. The case information has items for storing the case ID, company name, industry classification, scale, scenario ID, and case status. In the item of the case ID, the case ID that makes the case uniquely identifiable is stored. In the item of company name, the company name (company name) stored in the case information is stored.

The type of industry is hierarchically defined by the type of industry, and is classified into industry category 1, which represents the major category of the industry, industry category 2, which represents the middle category of the industry, and industry category 3, which stores the subdivision of the industry. According to the above classification, each item of the industry classification 1, the industry classification 2, and the industry classification 3 is provided in the item of the industry classification. In the example shown in FIG. 19, “Company A” is a company classified into the major category “steel industry”, the middle category “metal product manufacturing industry”, and the minor category “non-ferrous metal manufacturing industry”.

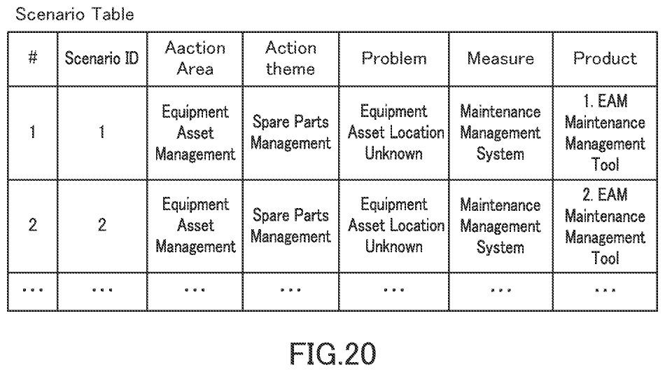

The scale of the company is stored in the scale item. The size of a company is defined, for example, by the number of employees. In the scenario ID item, the scenario ID that identifies the scenario registered in the case is stored. The scenario ID is defined by the scenario table shown in FIG. 20. Here, the case where the company attribute included in the project information is the industry classification and scale of the company will be described as an example, but the company attribute may include other conditions such as listing classification and region.

Information indicating the progress of the case is stored in the case status item. The progress of the project is classified into, for example, an order receiving stage, an unofficial announcement stage, a quotation presentation stage, a proposal stage, and an inquiry stage. As an example, if the case status is the order stage, it is “1”, if it is the informal stage, it is “2”, if it is the quotation presentation stage, it is “3”, if it is the proposal stage, it is “4”, and it is the inquiry stage. In that case, “5” is stored. The case status is blank (null) in the case registered for the first time.

The scenario table will be described with reference to FIG. 20. FIG. 20 is an example of a scenario table referred to in this embodiment. The scenario table is a table for defining a scenario ID for each scenario which is a route reaching from the start point layer to the end point layer in the problem organization database 321. In the scenario table shown in FIG. 20, a scenario in which the working area is the starting point layer and the product is the ending point layer is specifically defined.

The scenario table has items for storing scenario IDs, action areas, action themes, problems, measures, and products.

In the scenario ID item, the scenario ID that makes the scenario uniquely identifiable is stored. In the item of the action area, information for identifying the node arranged in the hierarchy of the action area is stored. In the item of the action theme, information for identifying the node arranged in the hierarchy of the action theme is stored. The problem item stores information that identifies the nodes arranged in the problem hierarchy. Information that identifies the nodes arranged in the hierarchy of the measure is stored in the item of the measure. Information that identifies the nodes arranged in the hierarchy of the service (product) is stored in the item of the product.

In the scenario table, all scenarios with the action area as the starting layer and the product as the ending layer are described, and different scenario IDs are defined for each scenario. As a result, the sales support device 30 can identify all the scenarios assumed in the problem organization database 321 by the scenario ID.

Next, the sales support device 30 refers to the case management table and confirms whether or not the case having the same case information and caser ID exists in the case management table (step S102).

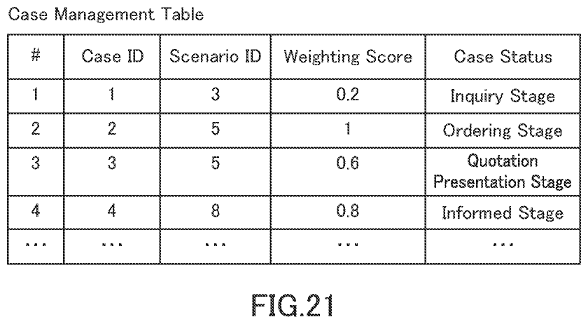

FIG. 21 is an example of the case management table referred to in this embodiment. The case management table is a table for managing the scenario and case status registered for each case. The case management table has items for storing case ID, scenario ID, weighting score, and case status. In the item of the case ID, the case ID that makes the case uniquely identifiable is stored. In the scenario ID item, the scenario ID that identifies the scenario registered in the case is stored.

In the weighted score item, the numerical value corresponding to the case status is stored. As an example, the weighting score is set so that the weighting value increases as the negotiation progresses. For example, “1” (100%) when the case status is in the ordering stage, “0.8” (80%) when it is in the informal stage, and “0.6” (60%) when it is in the quotation presentation stage, “0.4” (40%) is stored in the case of the proposal stage, and “0.2” (20%) is stored in the case of the inquiry stage. As described above, in the present embodiment, different weighting values can be set according to the case status. In addition, the current progress status of the case is stored in the case status item.

When a case with the same case information and case ID exists in the case management table (Yes in step S102), the sales support device 30 compares the above case with the same case ID and confirms whether the scenario ID is different (step S103).

If the scenario ID is different (Yes in step S103), the sales support device 30 updates based on the scenario ID. In this case, the sales support device 30 deletes the scenario ID and the weighting score of the case having the same case ID in the case management table (step S104), and stores the scenario ID of the case information in the case management table. Reflect the scenario ID of the case information in the management table (step S105).

In the weighting table for each company category, the sales support device 30 subtracts the numerical value deleted in the case management table from the weighting score of the same scenario ID as the deleted scenario ID (step S106). This process is a process of reflecting the deletion of the scenario ID in the case management table in the weighting score of the weighting table for each company category.

The weighting table for each company category is provided for each company category. By referring to the company classification table, the sales support device 30 can specify the company classification of the company related to the project and read out the weighting table for each company classification corresponding to the specified company classification.

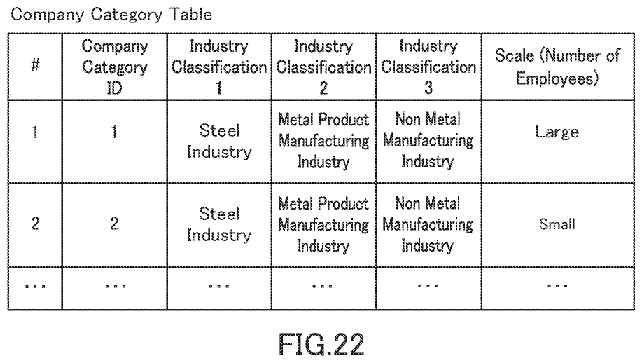

The company classification table will be described with reference to FIG. 22. FIG. 22 is an example of the company classification table in this embodiment. The company classification table is a table for defining a company classification ID for the type of business and the scale of the company, which is an example of the company attribute.

The company classification table has each item for storing the company classification ID, the industry classification (industry category 1, industry category 2, industry category 3), and the scale. In the item of the company classification ID, the company classification ID that makes the company classification uniquely identifiable is stored. The item of the industry category 1 stores the industry category 1 representing the major category of the industry, the item of the industry category 2 stores the industry category 2 representing the middle category of the industry, and the item of the industry category 3 stores the industry category 2. The industry category 3 that stores the sub-category of the industry is stored. The size item stores the size of the company.

In the company classification table, all combinations of expected industries and scales are described, and different company classification IDs are defined for each combination. As a result, the sales support device 30 can specify the company classification ID corresponding to the company from the company information included in the case information.

The weighting table for each company category will be described with reference to FIGS. 23A and 23B.

The weighting table for each company category is a table for managing the weighting scores set for each scenario. The weighting table for each company category has items for storing the scenario ID and the weighting score.

In the scenario ID item, the scenario ID that makes the scenario uniquely identifiable is stored. The weighted score item stores the weighted score set for the scenario. This means that, in the weighting table for each company category, weighting values are set for each scenario ID.

In addition, a weighting table for each company category is provided for each company category ID.

For example, the weighting table for each company category shown in FIG. 23A is a weighting table for each company category with the company category ID “1”, a weighting table for each company category with the company category ID “2”, and a scenario ID “1”, a weighting score of “2.6” is set for the scenario ID “2”, a weighting score of “3.2” is set for the scenario ID “2”, and a weighting score of “1.4” is set for the scenario ID “3”.

On the other hand, the weighting table for each company category shown in FIG. 23B is a weighting table for each company category with the company category ID “2”, and has a weighting score “4.6” and a scenario ID “4.6” for the scenario ID “1”. A weighting score “2.2” is set for “2”, and a weighting score “1.2” is set for the scenario ID “4”.

In this way, by preparing different weighting tables for each company classification ID, it is possible to set weighting scores according to the type of business and scale of the company.

The weighting score stored in the weighting table for each company classification is read out based on the company classification ID and the scenario ID of the company at the time of visiting the company, and is used when the scenarios are sorted and displayed in the order of the weights.

Next, the sales support device 30 reflects the weighted score of the case management table based on the case status of the case information, and updates the case status of the case management table (step S107). Then, the sales support device 30 updates the weighted value of the corresponding scenario ID in the weighted table for each company category by using the weighted score reflected in the case management table (step S108).

If the case information is not registered as a progressing case, it is determined in step S102 that the case having the same case information and case ID does not exist in the case management table. In this case (No in step S102), the sales support device 30 proceeds to the new registration procedure and registers the case ID and the scenario ID in the case management table (step S109). Then, after the sales support device 30 determines the company classification with reference to the business division and scale of this company (step S110), the sales support device 30 reflects the weighting score of the case management table in step S107, and the company in step S108. Update the weighting value of the corresponding scenario ID in the weighting table for each category.

If it is confirmed in step S103 that the scenario IDs are the same (Yes in step S103), the sales support device 30 skips the update based on the scenario ID. Then, in step S107, the weighting score of the case management table is reflected, and in step S108, the weighting value of the corresponding scenario ID in the weighting table for each company category is updated.

By the above processing, the sales support device 30 can set a weighted value from the company information.

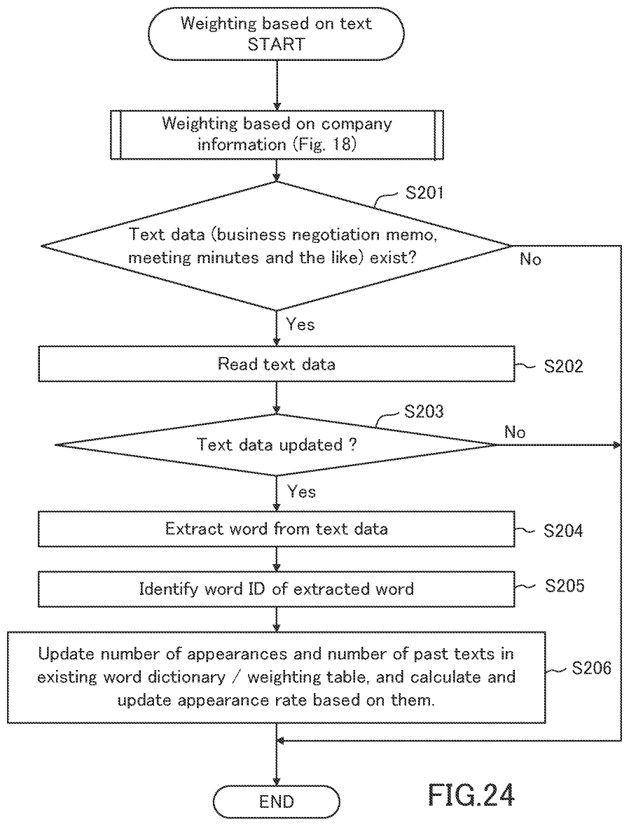

With reference to FIG. 24, a process of setting a weighted value based on text data (negotiation memo, meeting minutes, correspondence policy, and the like) included in the business negotiation result data will be described. FIG. 24 is a diagram showing an example of a weighted value setting process from text data in the present embodiment. The weighted value setting process according to the present invention is not limited to the process shown in FIG. 24.

In order to simplify the explanation, the process shown in FIG. 24 shall be performed following the process of setting the weighted value from the above-mentioned company information (flow chart shown in FIG. 18). However, the weighted value setting process from the text data does not necessarily have to be performed after the weighted value setting process from the company information.

The sales support device 30 can perform the weighting value setting process from the text data following the weighting value setting process from the company information. As shown in FIG. 24, the sales support device 30 confirms whether or not text data (business negotiation memo, meeting minutes, and the like) corresponding to a specific case exists (step S201). If the text data does not exist (No in step S201), the process ends.

If the text data exists (Yes in step S201), the sales support device 30 reads the text data (step S202) and confirms whether or not the text data has been updated (step S203). The sales support device 30 may refer to, for example, the update date and time of the text data, and confirm whether or not the text data has been updated after the previous processing date and time. If the text data has not been updated (No in step S203), the process ends.

When the text data is updated (Yes in step S203), the sales support device 30 performs a text data analysis process and extracts a word from the text data (step S204). Then, the sales support device 30 refers to the word list table and specifies the word ID of each extracted word (step S205).

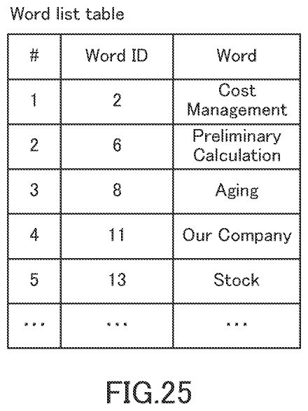

FIG. 25 is an example of a word list table referred to when extracting words in this embodiment.

The word list table is a table that manages the word IDs assigned to the word list. The word list table has a word ID and an item for storing a word.

In the word ID item, a word ID that makes it possible to uniquely identify a word is stored. The word item stores words that have already been extracted from the text data in the past. This means that, in the word list table, word IDs are assigned to each word extracted in the past.

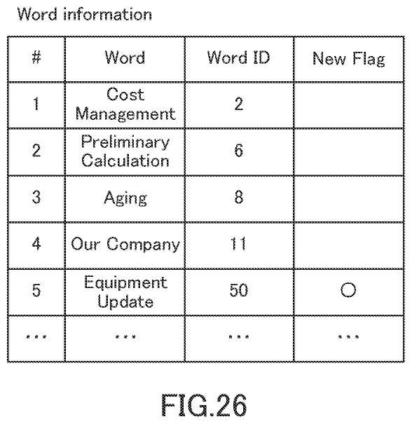

In addition, the word ID assigned in the word list table is given to the word extracted from the text data. FIG. 26 is an example of word information obtained by extracting a word from text data in the present embodiment. The word extracted from the text data is stored in a table having each item of word, word ID, and new flag. Words extracted from text data are stored in the word item. In the word ID item, the word ID specified from the word list table is stored for each word. In the new flag item, a flag indicating that the word is a new word that is not registered in the word list table is stored. When a new word that is not stored in the word list table is extracted, the flag is stored in the item of the new flag, the new word is added to the word list table, and the word ID is newly registered.

When the word ID of each word extracted from the text data is specified, the sales support device 30 reads the existing word dictionary/weighting table, updates the number of appearances and the number of past texts of the existing word dictionary/weighting table, and appears. The appearance rate (number of appearances/number of past texts) of each word calculated from the number of times and the number of past texts is updated (step S206).

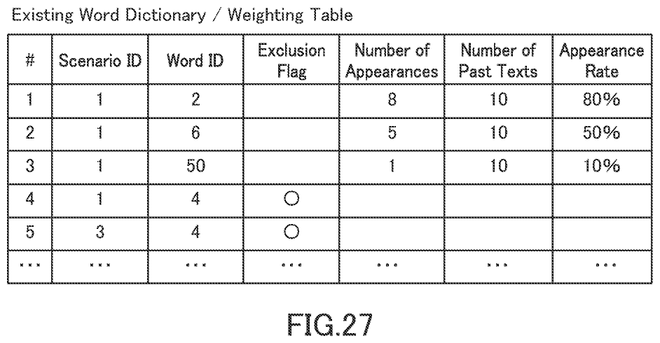

FIG. 27 is an example of an existing word dictionary/weighting table in this embodiment. The existing word dictionary/weighting table is a table provided for each scenario ID, and is a table for storing the appearance rate of words used in each scenario ID. For example, when the scenario ID set in the read case information is “1”, the sales support device 30 uses the existing word of the scenario ID “1” generated from the case of the past scenario ID “1”. Refer to the dictionary/weighting table as the processing target.

The existing word dictionary/weighting table has items for storing the scenario ID, word ID, exclusion flag, number of appearances, number of past texts, and appearance rate.

In the scenario ID item, the scenario ID that uniquely identifies the scenario is stored. In the word ID item, a word ID that uniquely identifies a word is stored. In the exclusion flag item, a flag indicating that the word is a frequently occurring word regardless of the service (product) is stored. A word for which an exclusion flag is set is considered to be a word that exists across a plurality of products.

The number of appearances item stores the number of times the word was extracted in the past text data. The total number of past text data is stored in the item of the number of past texts. The appearance rate item stores the appearance rate obtained by dividing the number of appearances by the number of past texts. For example, in the existing word dictionary/weighting table shown in FIG. 27, the word with the word ID “2” appears in the text data 8 times out of the total number of past text data (10 times), and the appearance thereof. Thus, the rate is calculated as “80%”.

The word appearance rate represents the percentage of words used in business negotiation memos and minutes in the past (utilization rate in business negotiations) related to a specific scenario. This means that it can be said that the higher the appearance rate of a specific word, the more appropriate the service related to the scenario in which the appearance rate of the word is high. In this respect, the word appearance rate has the same properties as the weighted value, and it is effective to reflect it in the display priority of the service. The word appearance rate may be merged into, for example, a weighted value to determine the display priority of the service. Alternatively, for example, the service arranged based on the weighted value and the service arranged based on the appearance rate of the word may be displayed in parallel (for example, in two columns), respectively, for each of the weighted value and the appearance rate of the word may be determined and the service may be displayed.

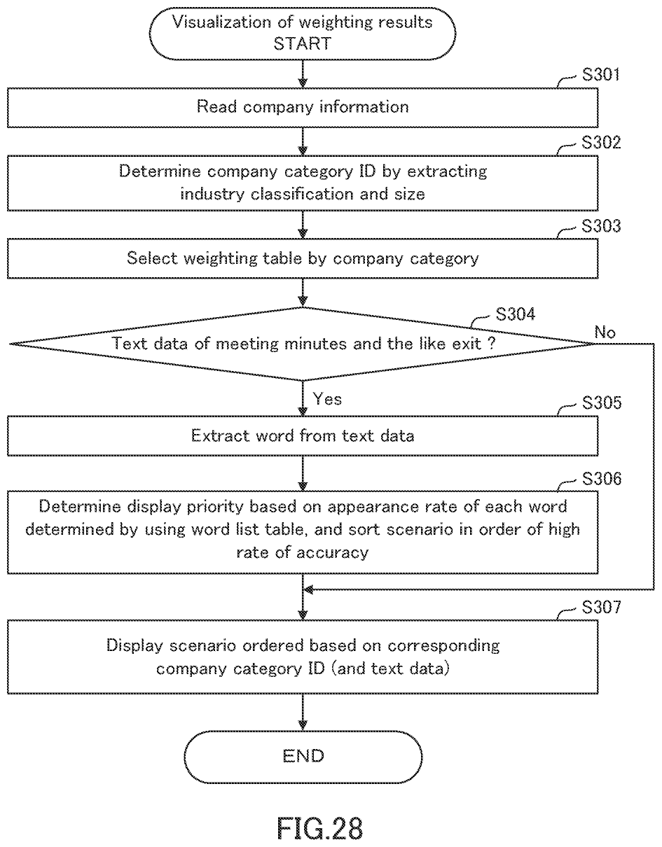

The process of visualizing the weighting will be described with reference to FIG. 28. FIG. 28 is a diagram showing an example of a weighting visualization process in the present embodiment. The weighting visualization process according to the present invention is not limited to the process shown in FIG. 28.

As shown in FIG. 28, the sales support device 30 reads the company information related to the specific company from the company database 45 based on the instruction from the sales terminal 10 (step S301). The sales support device 30 extracts the industry classification and scale of the company from the company information, specifies the company classification ID (step S302), and selects the weighting table for each company classification corresponding to the company classification ID (step S303).

Next, the sales support device 30 confirms whether or not text data such as minutes exists (step S304). When the text data does not exist (No in step S304) or when the text data is not considered, the weighted value set for the scenario ID is set to the company when the service is displayed on the above-mentioned service selection screen. Obtained from the weighting table for each category. The sales support device 30 displays a service as a product according to a scenario ranked based on the weighted value (step S307).

On the other hand, when the text data exists (Yes in step S304), the sales support device 30 extracts a word from the text data (step S305). The sales support device 30 identifies the appearance rate of each word from the word list table using the extracted word information, determines the display priority based on the appearance rate of each word, and sorts the scenarios in descending order of accuracy (step S306). Then, the sales support device 30 displays the service as a product according to the weighted value acquired from the weighted table for each company category and the scenario ranked based on the appearance rate of the word specified from the text data (step S307). At this time, as described above, the sales support device 30 may merge the weighted value and the word appearance rate to determine the display priority of the service, or the weighted value and the word appearance rate. The display priority of the service may be determined in each of the above, and the services may be displayed in parallel (for example, in two columns) based on each display priority.

In the weighting value setting process described with reference to FIG. 24, the appearance rate of words having the same properties as the weighting value is calculated based on the words extracted from the text data. Words may be extracted from data or audio data obtained from site surveys.

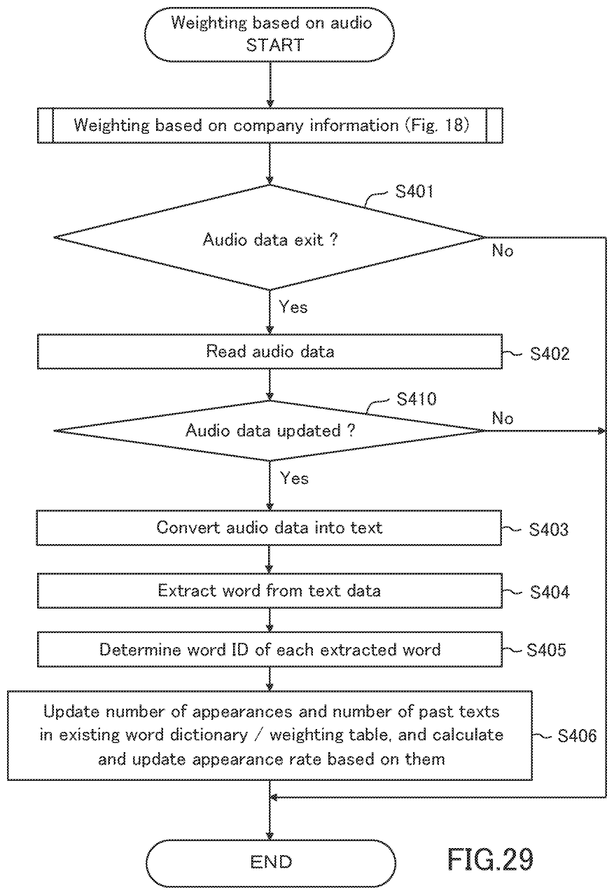

Hereinafter, the process of setting the weighted value based on the audio data will be described with reference to FIG. 29. FIG. 29 is a diagram showing an example of a weighted value setting process from audio data in the present embodiment. The weighted value setting process according to the present invention is not limited to the process shown in FIG. 29.

In order to simplify the explanation, the process shown in FIG. 29 shall be performed following the process of setting the weighted value from the above-mentioned company information (flow chart shown in FIG. 18). However, the weighted value setting process from the audio data does not necessarily have to be performed after the weighted value setting process from the company information.

The sales support device 30 can perform the weighting value setting process from the audio data, following the weighting value setting process from the company information. As shown in FIG. 29, the sales support device 30 confirms whether or not there is audio data (recorded data at the time of negotiation, audio data obtained in a site survey, and the like) corresponding to a specific case (step S401). If there is no audio data (No in step S401), the process ends.

When the audio data exists (Yes in step S401), the sales support device 30 reads the audio data (step S402) and confirms whether or not the audio data has been updated (step S403). The sales support device 30 may refer to, for example, the update date and time of the audio data and confirm whether or not the audio data is updated after the previous processing date and time. If the audio data has not been updated (No in step S403), the process ends.

When the audio data is updated (Yes in step S403), the sales support device 30 performs voice text conversion processing to convert the audio data into text (step S410), and further performs text data analysis processing, thereby to extract words from the text data (step S404). Then, the sales support device 30 refers to the word list table and specifies the word ID of each extracted word (step S405).

When the word ID of each word extracted from the text data is specified, the sales support device 30 reads the existing word dictionary/weighting table, updates the number of appearances and the number of past texts of the existing word dictionary/weighting table, and appears. The appearance rate (number of appearances/number of past texts) of each word calculated from the number of times and the number of past texts is updated (step S406).

Comparing the processing for the text data shown in FIG. 24 and the processing for the audio data shown in FIG. 29, when handling the audio data, it differs only in that the audio data is converted into text in step S410. However, it is preferable that the word list table and the existing word dictionary/weighting table are divided into those for text data processing and those for audio data processing. The words and phrases used are different between written language (written language) and spoken language (spoken language), and by separating each table, it is possible to calculate the appearance rate of words more accurately.

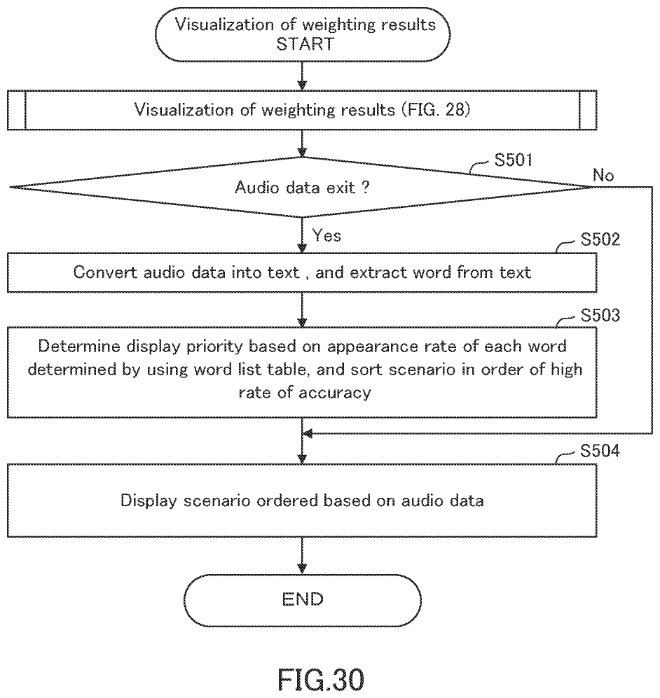

The process of visualizing the weighting based on the audio data will be described with reference to FIG. 30. FIG. 30 is a diagram showing an example of a weighting visualization process based on audio data in the present embodiment. The weighting visualization process according to the present invention is not limited to the process shown in FIG. 30.

The process shown in FIG. 30 is assumed to be performed following the weighted visualization process (flow chart shown in FIG. 28) described above in order to simplify the explanation. However, the weighting visualization process based on the audio data does not necessarily have to be performed after the weighting visualization process described above.

The sales support device 30 can perform a weighting visualization process based on audio data, following a weighting visualization process based on company information and text data.

As shown in FIG. 30, the sales support device 30 confirms whether or not audio data exists (step S501). If the audio data does not exist (No in step S501) or if the audio data is not considered, the process ends.

On the other hand, when audio data exists (Yes in step S501), the sales support device 30 converts the audio data into text and extracts a word from the text data (step S502), and uses the extracted word information to create a word list table, and specify the appearance rate of each word from the word list table, using the extracted word information. The sales support device 30 determines the display priority from the appearance rate of each word in descending order of accuracy and rearranges the scenarios (step S503). Then, the sales support device 30 displays the service as a product according to the scenario ranked based on the appearance rate of the word specified from the audio data (step S504). At this time, the sales support device 30 merges a plurality or all of the weighted values, the appearance rate of the word obtained from the text data, and the appearance rate of the word obtained from the audio data, and displays the service display priority. Or may determine the display priority of the service in each of the weighted value and the word occurrence rate.

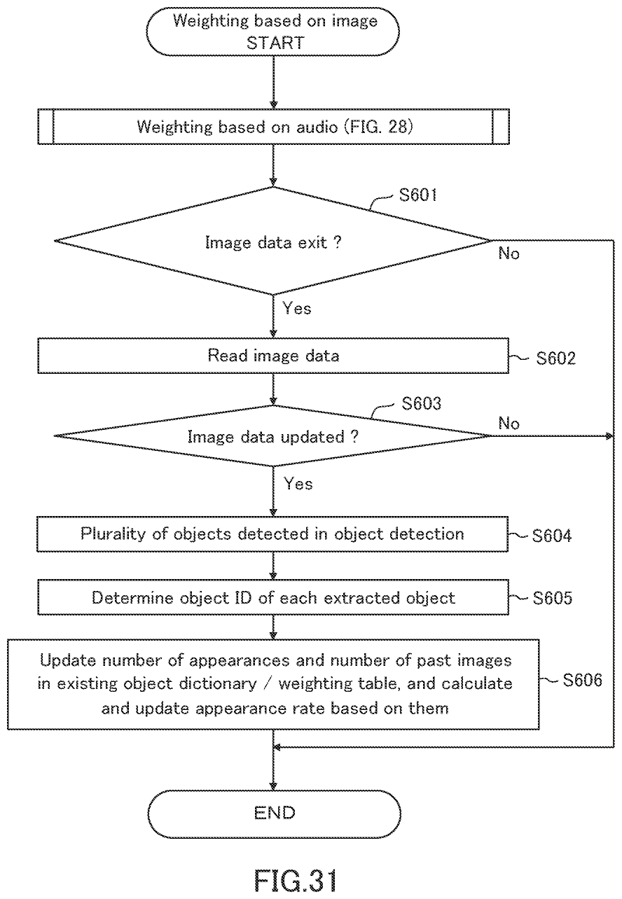

Hereinafter, the process of setting the weighting value based on the image data will be described with reference to FIG. 31. FIG. 31 is a diagram showing an example of a weighted value setting process from image data in the present embodiment. The weighted value setting process according to the present invention is not limited to the process shown in FIG. 31.

In order to simplify the explanation, the process shown in FIG. 31 shall be performed following the above-mentioned process of setting the weighted value from the audio data (flow chart shown in FIG. 29). However, the weighting value setting process from the image data does not necessarily have to be performed after the weighting value setting process from the audio data.

The sales support device 30 can perform the weighting value setting process from the image data following the weighting value setting process from the audio data. As shown in FIG. 31, the sales support device 30 confirms whether or not image data (image data taken at the time of business negotiation, image data obtained in a site survey, and the like) exists corresponding to a specific project (step S601). If the image data does not exist (No in step S601), the process ends.

When the image data exists (Yes in step S601), the sales support device 30 reads the image data (step S602) and confirms whether or not the image data has been updated (step S603). The sales support device 30 may refer to, for example, the update date and time of the image data, and confirm whether or not the image data is updated after the previous processing date and time. If the image data has not been updated (No in step S603), the process ends.

When the image data is updated (Yes in step S603), the sales support device 30 performs image analysis processing to perform object detection, and detects an object (shot object) from the image data (step S604). Then, the sales support device 30 refers to the object list table and specifies the object ID of each extracted object (step S605).

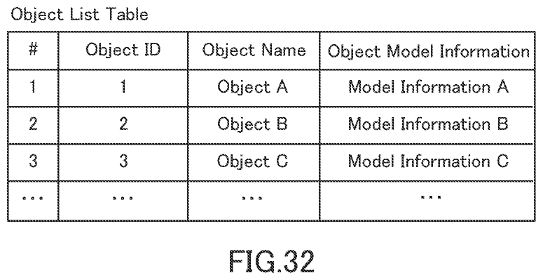

FIG. 32 is an example of an object list table referred to when extracting a word in the present embodiment.

The object list table is a table that manages the object IDs assigned to the object list. The object list table has items for storing the object ID, the object name, and the object model information.

The object ID item stores the object ID that makes the object uniquely identifiable. The object name item stores the name of the object. In the object model information item, information for identifying the object model used at the time of object detection is stored. Deep learning techniques can be applied to object detection, and by using a trained model as an object model, objects that match the object model can be detected from image data. As described above, in the object list table, object IDs are assigned to objects that can be detected by object detection.

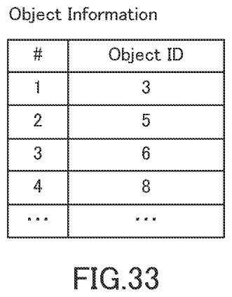

In addition, the object ID assigned in the object list table is assigned to the object extracted from the image data. FIG. 33 is an example of object information obtained by extracting an object from image data in the present embodiment. The object extracted from the image data is stored in the table having the item of the object ID. In the item of object ID, the object ID specified from the object list table is stored for each object extracted from the image data.

When the object ID of each object extracted from the image data is specified, the sales support device 30 reads the existing object dictionary/weighting table, updates the number of appearances and the number of past images of the existing object dictionary/weighting table, and appears. The appearance rate (number of appearances/number of past images) of each object calculated from the number of times and the number of past images is updated (step S606).

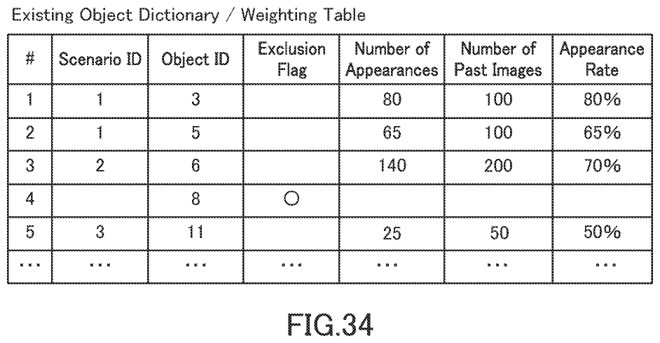

FIG. 34 is an example of an existing object dictionary/weighting table in this embodiment. The existing object dictionary/weighting table is a table provided for each scenario ID, and is a table for storing the appearance rate of objects related to each scenario ID. For example, when the scenario ID set in the read case information is “1”, the sales support device 30 refers to the dictionary/weighting table as the processing target of an existing object of the scenario ID “1” generated from the case of the past scenario ID “1”.

The existing object dictionary/weighting table has items for storing the scenario ID, object ID, exclusion flag, number of appearances, number of past images, and appearance rate.

In the scenario ID item, the scenario ID that uniquely identifies the scenario is stored. The object ID item stores the object ID that uniquely identifies the object. In the exclusion flag item, a flag indicating that the object is a frequently occurring object regardless of the service (product) is stored. Objects for which the exclusion flag is set are considered to be objects that exist across multiple products.

The number of appearances item stores the number of times the object was detected in the past image data. In the item of the number of past images, the total number of past image data is stored. The appearance rate item stores the appearance rate obtained by dividing the number of appearances by the number of past images. For example, in the existing object dictionary/weighting table shown in FIG. 34, the word of object ID “1” appears in 80 times of the total number of past image data (100 times), and its appearance. Thus, the rate is calculated as “80%”.

The appearance rate of objects represents the percentage of objects detected from image data in the past in relation to a specific scenario. This means that it can be said that the higher the appearance rate of a specific object, the more appropriate the service related to the scenario in which the appearance rate of the object is high. In this respect, the appearance rate of the object has the same property as the weighted value, and it is effective to reflect it in the display priority of the service. The appearance rate of the object may be merged with the weighted value, for example, to determine the display priority of the service, or the display priority of the service may be determined for each of the weighted value and the appearance rate of the object.

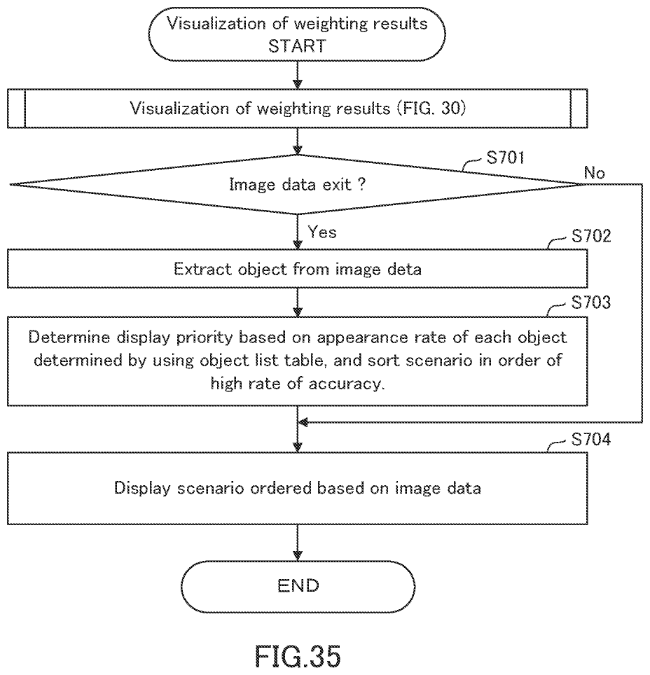

The process of visualizing the weighting based on the image data will be described with reference to FIG. 35. FIG. 35 is a diagram showing an example of a weighting visualization process based on image data in the present embodiment. The weighting visualization process according to the present invention is not limited to the process shown in FIG. 35.

The process shown in FIG. 35 is assumed to be performed following the weighted visualization process (flow chart shown in FIG. 30) described above in order to simplify the explanation. However, the weighting visualization process based on the image data does not necessarily have to be performed after the weighting visualization process described above.

The sales support device 30 can perform a weighting visualization process based on image data, following a weighting visualization process based on the company information, text data, and audio data.

As shown in FIG. 35, the sales support device 30 confirms whether or not the image data exists (step S701). If the image data does not exist (No in step S701) or if the image data is not considered, the process ends.

On the other hand, when the image data exists (Yes in step S701), the sales support device 30 extracts the object from the image data, converts it into object list information text, and extracts the object from the text data (step S702). The sales support device 30 identifies the appearance rate of each object from the object list table using the extracted object information, determines the display priority based on the appearance rate of each object, and sorts the scenarios in descending order of accuracy. (Step S703). Then, the sales support device 30 displays the service as a product according to the scenario ranked based on the appearance rate of the object detected from the image data (step S704). At this time, the sales support device 30 may have a plurality of weighted values, a word appearance rate obtained from text data, a word appearance rate obtained from audio data, and an object appearance rate detected from image data. All may be merged to determine the display priority of the service, or the display priority of the service may be determined for each of the weighted value, the word appearance rate, and the object appearance rate.

According to the above embodiment, there is provided a sales support system 1 that supports the sales activities of related parties including sales staff who hold business negotiations with a company that is a customer, or is used by the customer himself/herself and includes sales staff, the sales support system comprising: a sales terminal 10 that can be operated by a person or a customer; and a sales support device 30 that can communicate with the sales terminal 10, wherein the sales support device 30 has at least a problem organization database 321 in which a problem, a measure to solve the problem, and a service that contributes to the measure are hierarchically connected, and a sales support processing unit 32 that displays a plurality of the problems set in the problem organization database 321 on the display screen of the sales terminal 10 to be selectable, selectably displays a plurality of measures connected to the lower layer of the problem on the display screen of the sales terminal 10 when a plurality of problems are displayed on the display screen of the sales terminal 10 are selected, displays a plurality of services connected to services connected to the lower layer of the measure on the display screen of the sales terminal 10 when a plurality of measures are displayed on the display screen of the sales terminal 10 are selected.

According to the above embodiment, there is provided a sales support method in the sales support system 1 that supports the sales activities of related parties including the sales staff who negotiate with the customer company, or is used by the customer himself/herself, wherein the sales support system prepares at least a problem organization database 321 in which problems, measures for solving problems, and services that contribute to the measures are hierarchically connected, displays a plurality of problems set in the problem organization database 321 to be selectable on the display screen of the sales terminal 10 that can be operated by related parties including sales staff or customers themselves, selectably displays a plurality of measures connected to the lower layer of the problem when a plurality of problems are displayed on the display screen of the sales terminal 10 are selected, displays a plurality of services connected to services connected to the lower layer of the measure when a plurality of measures are displayed on the display screen of the sales terminal 10 are selected.

The present invention is not limited to the above-described embodiment, but includes various modifications and design changes within the scope that does not deviate from the technical idea of the present invention.

### EXPLANATION OF REFERENCE NUMERALS

1 Sales Support System
10 Sales Terminal
20 Site Survey Terminal
30 Sales Support Device
32 Sales Support Processing Unit
33 Weighting Processing Unit
34 Collected Data Analysis Unit
40 Customer Management System
45 Customer Database
50 Network
101, 201, 301 Processors
102, 202, 302 Memory
103, 203, 303 Communication Unit
104, 204, 304 Operation Input Unit
105, 205, 305 Monitors
106, 206 Microphones
107, 207 Cameras
108, 208, 306 Storage
111 Web Browser Program
150, 250, 350 Buses
211 Recording Processing Program
212 Shooting Processing Program
213, 341 Collected Data
311 Web Server Program
312 Sales Support Program
313 Weighting Processing Program
314 Collected Data Analysis Program
321 Problem Organization Database
322 Various Table Groups
331 Business Negotiation Result Data
2131, 3411 Text Data
2132, 3412 Audio data
2133, 3413 Image Data
3143 Image Analysis Program
3144 Deep Learning Program

1. A sales support system that supports sales activities of related parties including sales staff who negotiate with a customer company, or the sales support system used by a customer himself/herself, the sales support system comprising:
a sales terminal that can be operated by a person concerned including the sales staff or the customer; and
a sales support device that can communicate with the sales terminal, wherein,
the sales support device has a problem organization database, systematically connected to at least problems, measures to solve the problems, and services contributing to the problems, and
a sales support processing unit that: displays a plurality of problems set in the problem organization database on a display screen of the sales terminal so that the problems can be selected; displays the plurality of measures connected to the lower layers of the plurality of problems on the display screen of the sales terminal so that the measures can be selected, when the plurality of problems displayed on the display screen of the sales terminal are selected; and displays the plurality of services connected to the lower layers of the plurality of services on the display screen of the sales terminal, when the plurality of measures displayed on the display screen of the sales terminal are selected.

2. The sales support system according to claim 1, wherein,
the sales support processing unit collectively displays the plurality of selected problems, the plurality of selected measures, and the plurality of services connected to the lower layers of the plurality of the selected measures on the display screen of the sales terminal.

3. The sales support system according to claim 1, wherein,
the sales support device has a weighted value setting unit that assigns a weighted value to each of a plurality of connection routes having a service hierarchy as an end point from the problem hierarchy to the measure hierarchy in the problem organization database,
when the sales support processing unit displays a plurality of services on the display screen of the sales terminal, the display priority of the plurality of services to be displayed is determined based on the weighted value set in a connection path having each of the plurality of services to be displayed as an end point.

4. The sales support system according to claim 3, wherein,
the weighted value setting unit sets the weighted value based on the company attribute.

5. The sales support system according claim 4, wherein,
the company attribute includes at least one of business type, scale, listing classification, and region of the company.

6. The sales support system according to claim 4, wherein,
the weighted value setting unit sets the weighted value based on the negotiation history for another company having the same company attribute.

7. The sales support system according to claim 3, wherein,
the weighted value setting unit sets the weighted value according to the progress of the business negotiation.

8. The sales support system according to claim 3, wherein,
the weighted value setting unit sets the weighted value based on the information about the company obtained in the business negotiation or the survey.

9. The sales support system according to claim 8, wherein,
the information about the company is text data, and the weighted value setting unit sets the weighted value based on the word extracted from the text data.

10. The sales support system according to claim 8, wherein,
the information about the company is audio data, and the weighted value setting unit sets the weighted value based on the word extracted from the audio data.

11. The sales support system according to claim 8, wherein,
the information about the company is image data, and the weighted value setting unit sets the weighted value based on the object detected from the image data.

12. The sales support system according to claim 8, wherein,
the weighted value setting unit extracts features of information about the company by deep learning technology and sets the weighted values based on the extracted features.

13. The sales support system according to claim 1, wherein,
in the problem organization database, a layer including a problem derivation item for deriving the problem is connected as an upper layer of the problem,
the sales support processing unit displays a plurality of problem derivation items for deriving the problem on the display screen of the sales terminal so that a plurality of the problem deviation items can be selected, when a plurality of problem deviation items displayed on the display terminal of the sales terminal are selected, a plurality of problems connected to a lower layer of the plurality of selected problem derivation items are displayed on the display screen of the sales terminal.

14. The sales support system according to claim 13, wherein,
a management vision, a strategic theme, a business flow, and an action theme are hierarchically connected in the layer including the problem derivation item.

15. A sales support method in a sales support system that supports the sales activities of related parties including sales staff who negotiate with the customer company, or the sales staff used by the customer himself/herself, wherein the sales support method has:
a step to prepare a problem organization database in which at least a problem, a measure to solve the problem, and a service that contributes to the measure are hierarchically connected;
a step to display a plurality of problems that are set in the problem organization database so that a plurality of problems can be selected on a display screen of a sales terminal that can be operated by the related parties including the sales staff or the customer himself/herself;
a step to display a plurality of measures that are connected to a lower layer of the plurality of the selected problems when a plurality of problems displayed on the display screen of the sales terminal are selected; and
a step to display a plurality of services that are connected to a lower layer of the plurality of the selected measures when a plurality of measures displayed on the display screen of the sales terminal are selected.
